(19) United States
(12) Patent Application Publication
(10) Pub. No.: US 2007/0060164 A1
(43) Pub. Date: Mar. 15, 2007

(54) Method and apparatus for controlling reduced slot cycle mode for paging in a mobile communication system, and system thereof

(76) Inventors: Yu-Chul Kim, Suwon-si (KR); Dae-Gyun Kim, Seongnam-si (KR); Beom-Sik Bae, Suwon-si (KR); Jung-Soo Jung, Seoul (KR); Hwan-Jonn Kwon, Suwon-si (KR); Dong-Hee Kim, Yongin-si (KR); Rajkotia Purva R., Plano, TX (US); Youn-Sun Kim, Seongnam-si (KR); Jun-Kyu Han, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/484,024

(22) Filed: Jul. 11, 2006

Related U.S. Application Data
(63) Continuation-in-part of application No. 11/217,395, filed on Sep. 2, 2005.

(30) Foreign Application Priority Data
Sep. 20, 2004 (KR) 10-2004-0075169
Sep. 2, 2004 (KR) 10-2004-0069784
Jul. 11, 2005 (KR) 10-2005-0062467

(51) Int. Cl. H04Q 7/20

(52) U.S. Cl. 455/450

(57) ABSTRACT

A reduced slot cycle (RSC) mode control method is provided for observing a paging slot by a mobile station to receive a message transmitted from a base station in a mobile communication system. The method includes the steps of determining at least one parameter related to an operation time of the RSC mode and the number of operation periods where the mobile station operate with different slot cycle indexes (SCIs), through an exchange of at least one message with the base station, calculating a per-SCI operation time in the RSC mode operation time using the determined parameter, and starting the RSC mode, setting a reduced slot cycle index (RSCI) as an initial value of the SCI determined between the mobile station and the base station, wherein the RSCI has a value smaller than an SCI value of an idle state, increasing the SCI value step by step each time the SCI operation time of slot period arrives, and terminating the RSC mode if the increased SCI value reaches the SCI value of the idle state.

### CROSS-REFERENCE TO RELATED APPLICATIONS

This application is a Continuation-In-Part of U.S. patent application Ser. No. 11/217,395, filed Sep. 2, 2005, entitled “Method And System For Controlling Reduced Slot Cycle Mode For Paging In A Mobile Communication System”, and claims the benefit under 35 U.S.C. §119(a) of Korean Patent Application No. 10-2005-0062467, filed in the Korean Intellectual Property Office on Jul. 11, 2005, the entire disclosure of which is incorporated herein by reference.

### BACKGROUND OF THE INVENTION

1. Field of the Invention

The present invention relates generally to a method and system for controlling a slot cycle mode for paging in a mobile communication system. More particularly, the present invention relates to a method and system for controlling a reduced slot cycle (RSC) mode for reducing a call connection time of a mobile station.

2. Description of the Related Art

In general, a mobile station supporting Code Division Multiple Access (CDMA) operates in one of the following four states.

In an initialization state, the mobile station searches for a base station and performs its basic setting operation upon power-on. In an idle state, the mobile station has no channel directly connected to the base station and observes only the common signaling channel. In a system access state, the mobile station accesses the base station to transmit a message through a reverse common signaling channel. Finally, in a traffic channel state, the mobile station has a traffic channel directly connected to the base station so that it can exchange voice or packet data with the base station over the traffic channel.

Particularly in the idle state, the mobile station observes a forward paging channel (F-PCH) or a forward common control channel (F-CCCH), which are forward common signaling channels (F-CSCH), in order to receive a message transmitted from the base station. The F-PCH or the F-CCCH transmits messages per slot, which is a particular time period, and the slots can be uniquely allocated to mobile stations. Each slot has a unique slot number, and the mobile station observes a corresponding slot if it is determined that a slot number of the corresponding slot is identical to the slot number allocated thereto. A slot allocated to each mobile station is called a “paging slot”, and the mobile station receives a message transmitted thereto through the paging channel.

In the idle state, in the process of observing the F-PCH or the F-CCCH, the mobile station wakes up only for a time period of the slot allocated thereto to observe the channel and does not observe the other slots, in order to reduce power consumption to the greatest extent. This is referred to as a “slotted mode”. That is, the mobile station in the idle state performs a slot mode operation using a predetermined paging slot position and a predetermined paging slot cycle length. In a CDMA mobile communication system, the paging slot cycle length is represented by a slot cycle index (SCI), and the SCI has a value of −7 through 4. Table 1 below shows by way of example a relationship between a slot cycle length mapped to each SCI value supported in CDMA2000 Rev. D, and a frequency which is a reciprocal of the slot cycle length.

TABLE 1

| Slot Cycle Index | Slot Cycle Length | |
|---|---|---|
| Value | (sec) | Frequency (1/sec) |
| −7 | Non-slotted | — |
| −4 | 0.08 s (1 slot) | 1/0.08 |
| −3 | 0.016 s (2 slots) | 1/0.016 |
| −2 | 0.032 s (4 slots) | 1/0.032 |
| −1 | 0.064 s (8 slots) | 1/0.064 |
| 0 | 1.28 s (16 slots) | 1/1.28 |
| 1 | 2.56 s (32 slots) | 1/2.56 |
| 2 | 5.12 s (64 slots) | 1/5.12 |
| 3 | 10.24 s (128 slots) | 1/10.24 |
| 4 | 20.48 s (256 slots) | 1/20.48 |
| 5 | 40.96 s (512 slots) | 1/40.96 |
| 6 | 81.92 s (1024 slots) | 1/81.92 |
| 7 | 163.84 s (2048 slots) | 1/163.84 |

In order to connect a new call to the mobile station in the idle state, it is necessary to inform the mobile station of the presence of the new call. This is possible by transmitting a General Page Message (GPM) or a Universal Page Message (UPM) indicating the presence of the new call to the mobile station through the F-PCH or the F-CCCH. Regarding the call connection, to reduce a call connection setting time of the mobile station in the idle state in, for example, a fast messaging service or a Push-To-Talk (PTT) service, a method has been proposed for reducing an SCI value of a mobile station.

The PTT service such as Direct Connect^{SM} service by Nextel provides a service in which two mobile stations operate as walkie-talkies. In the PTT service, the two mobile stations enter the idle state after a page connection is set up between the two mobile stations. If a user of a calling mobile station transmits a voice message to a user of a called mobile station at a particular time, the called mobile station should preferably be able to immediately receive the voice message. Therefore, in the PTT service, the mobile stations cannot operate properly in the slot mode having the minimum cycle of 1.28 sec.

In these and other services requiring fast messaging, such as game applications and PTT service, if an SCI value of the mobile station is reduced below that of the general slot mode, a slot cycle length of the F-PCH or F-CCCH decreases, reducing an average time required when the mobile station receives a message from a base station. However, if the mobile station continuously uses the reduced SCI value during the idle state, battery consumption increases. In order to prevent the increase in the battery consumption, CDMA2000 Rev. D has proposed a reduced slot cycle (RSC) mode in which a base station and a mobile station operate with an SCI value being less than a normal SCI value for a predefined time.

The conventional RSC mode is classified into a mobile station-requested RSC mode and a base station-requested RSC mode during call release, according to the subject of the request.

Table 2 below illustrates by way of example a field format of a Release Order (RO) message transmitted from a mobile station to a base station in the mobile station-requested RSC mode. It should be noted that numerals shown in all of the following tables, including Table 2, represent the number of bits for corresponding information, unless otherwise stated.

TABLE 2

| | |
|---|---|
| RSC_MODE_IND | 1 |
| RSCI | 0 or 4 |
| RSC_END_TIME_UNIT | 0 or 2 |
| RSC_END_TIME_VALUE | 0 or 4 |

For call release, the mobile station requests the RSC mode by transmitting to the base station the RO message, in which an RSC mode indication (RSC_MODE_IND) field is set to ‘1’ and the succeeding fields carry a Reduced Slot Cycle Index (RSCI) being set to less than an SCI (SLOT_CYCLE_INDEX_REG) value registered by the mobile station in the idle state, and RSC mode operation time information (RSC_END_TIME_UNIT and RSC_END_TIME_VALUE).

Table 3 below illustrates by way of example a field format of an Extended Release Message (ERM) message used when the base station receiving the RO message transmits to the mobile station, information indicating whether it supports the RSC mode and the maximum RSC mode operation time information, or used when the base station requests the RSC mode.

TABLE 3

| | |
|---|---|
| RSC_MODE_SUPPORTED | 1 |
| MAX_RSC_END_TIME_UNIT | 0 or 2 |
| MAX_RSC_END_TIME_VALUE | 0 or 4 |
| REQ_RSCI_INCL | 0 or 1 |
| REQ_RSCI | 0 or 4 |

Upon receiving the ERM message, the mobile station operates in the RSC mode using the RSCI value for the shorter of a time selected between the RSC mode operation time requested by the mobile station, and the maximum RSC operation time represented by MAX_RSC_END_TIME_UNIT and MAX_RSC_END_TIME_VALUE provided by the base station. The mobile station, even though it fails to receive the ERM message from the base station, performs the RSC mode operation for a time requested by the mobile station through the RSCI field of Table 2.

In the base station-requested RSC mode during call release, the base station transmits an RSCI value (REQ_RSCI) requested by the base station and the maximum RSC mode operation time information (MAX_RSC_END_TIME_UNIT and MAX_RSC_END_TIME_VALUE) to the mobile station through the ERM message, in which an RSC mode support (RSC_MODE_SUPPORTED) field of Table 3 is set to ‘1’ indicating that the base station supports the RSC mode.

The mobile station receiving the ERM message transmits its desired RSCI value and information on an RSC operation time that is shorter than the maximum RSC mode operation time, to the base station through an Extended Release Response Message (ERRM) message. After transmitting the ERRM message, the mobile station starts the RSC mode operation according to the parameter value.

As described above, the mobile station and the base station use the RO message, the ERM message and the ERRM message to release a call in the traffic channel state. However, in order for a mobile station in the idle state to operate in the RSC mode, the mobile station can perform a process of setting the RSC mode operation using a Fast Call Setup Order (FCSO) message. Both the mobile station and the base station can request the RSC mode operation or respond to the request by transmitting the FCSO message, and the parameters transmitted through the FCSO message are equal to those used when a call is released in the traffic channel state.

If the RSC mode is started through transmission of the RO message, the ERM message, the ERRM message, or the FCSO message, one or both of the mobile station and the base station operate for a predetermined RSC mode operation time using an RSCI value, which is less than the SCI value used by the mobile station in a normal case where they do not operate in the RSC mode. In the normal case, a value stored in the mobile station is used as the SCI value of the mobile station. However, when operating in the RSC mode, the mobile station uses a preferred value that is less than or equal to the smaller one of the RSCI value and the SCI value.

If the RSC mode operation time becomes longer than a predetermined operation time, the RSC mode ends, and a preferred SCI of the mobile station, indicating a slot cycle index of the general idle state in which the RSC mode operation is not performed, is replaced with the SCI value. The SCI value is defined as in Equation (1) below.
max(MIN_SCI, min(SCI_REG, MAX_SCI)) (1)

In Equation (1), SCI_REG denotes an SCI value that the mobile station has last transmitted to the base station through a direct/indirect registration process. This is shown in greater detail in FIG. 1.

FIG. 1 is a conceptual diagram for illustrating an operation of the conventional RSC mode. In FIG. 1, T represents an RSC mode operation time. After a lapse of the RSC mode operation time T, the RSC mode ends. Thereafter, the mobile station and the base station operate with the preferred SCI.

Accordingly, a need exists for an RSC mode control system and method that reduces a delay time required when a base station transmits a message to a mobile station, and provides higher RSC mode performance with less energy consumption.

### SUMMARY OF THE INVENTION

It is, therefore, an object of embodiments of the present invention to substantially solve the above and other problems, and provide a method and system for controlling a reduced slot cycle (RSC) mode for reducing a call connection time of a mobile station in a mobile communication system.

It is another object of embodiments of the present invention to provide a method and system for controlling an RSC mode that provides efficient service when requiring fast messaging.

It is yet another object of embodiments of the present invention to provide a method and system for controlling an RSC mode that is capable of independently setting an operation time for each SCI.

According to one aspect of embodiments of the present invention, a reduced slot cycle (RSC) mode control method is provided for observing a paging slot by a mobile station to receive a message transmitted from a base station in a mobile communication system. The method comprises the steps of determining at least one parameter related to an operation time of the RSC mode and the number of operation periods where the mobile station operate with different slot cycle indexes (SCIs), through an exchange of at least one message with the base station, calculating a per-SCI operation time in the RSC mode operation time using the determined parameter, and starting the RSC mode, setting a reduced slot cycle index (RSCI) as an initial value of the SCI determined between the mobile station and the base station, wherein the RSCI has a value smaller than an SCI value of an idle state, increasing the SCI value step by step each time the per-SCI operation time arrives, and terminating the RSC mode if the increased SCI value reaches the SCI value of the idle state.

According to another aspect of embodiments of the present invention, a mobile station apparatus is provided for performing a reduced slot cycle (RSC) mode for observing a paging slot to receive a message transmitted from a base station in a mobile communication system. The apparatus comprises a radio frequency (RF) transmission/reception module for exchanging a radio signal with the base station via an antenna, a message processor for transmitting and receiving various messages including parameters for control of the RSC mode, and an RSC controller. The RSC controller is provided for determining at least one parameter related to an operation time of the RSC mode and the number of operation periods where the mobile station operate with different slot cycle indexes (SCIs), through an exchange of at least one message with the base station, calculating a per-SCI operation time in the RSC mode operation time using the determined parameter, and starting the RSC mode, setting a reduced slot cycle index (RSCI) as an initial value of the SCI determined between the mobile station and the base station, the RSCI having a value smaller than an SCI value of an idle state, increasing the SCI value step by step each time the per-SCI operation time arrives, and terminating the RSC mode if the increased SCI value reaches the SCI value of the idle state.

According to yet another aspect of embodiments of the present invention, a base station apparatus is provided that operates in a reduced slot cycle (RSC) mode by exchanging a message with a mobile station that periodically observes a paging slot, in a mobile communication system. The apparatus comprises a radio frequency (RF) transmission/reception module for exchanging a radio signal with the mobile station, a message processor for transmitting and receiving various messages including parameters for control of the RSC mode, and an RSC controller. The RSC controller is provided for determining at least one parameter related to an operation time of the RSC mode and the number of operation periods where the base station operate with different slot cycle indexes (SCIs), through an exchange of a message with the mobile station, calculating a per-SCI operation time in the RSC mode operation time using the determined parameter, setting a paging slot position of the mobile station and a paging slot observation period, setting a reduced slot cycle index (RSCI) as an initial value of the SCI determined between the mobile station and the base station, the RSCI having a value smaller than an SCI value of an idle state, and terminating the RSC mode with the mobile station if the increased SCI value reaches the SCI value of the idle state, the SCI value increasing step by step each time the per-SCI operation time arrives.

According to yet another aspect of embodiments of the present invention, a mobile communication system is provided that controls a reduced slot cycle (RSC) mode in which a mobile station in an idle state observes a paging slot to receive a message transmitted from a base station. The system comprises the mobile station for determining at least one parameter related to an operation time of the RSC mode and the number of operation periods where the mobile station operate with different slot cycle indexes (SCIs), through an exchange of at least one message with the base station, calculating a per-SCI operation time in the RSC mode operation time using the determined parameter, and starting the RSC mode, setting a reduced slot cycle index (RSCI) as an initial value of the SCI determined between the mobile station and the base station, the RSCI having a value smaller than an SCI value of an idle state, increasing the SCI value step by step each time the per-SCI operation time arrives, and terminating the RSC mode if the increased SCI value reaches the SCI value of the idle state, and the base station for recognizing the start of the RSC mode by the mobile station by exchanging the message with the mobile station, and providing the parameter to the mobile station.

### BRIEF DESCRIPTION OF THE DRAWINGS

The above and other objects, features and advantages of embodiments of the present invention will become more apparent from the following detailed description when taken in conjunction with the accompanying drawings, in which:

FIG. 1 is a conceptual diagram for illustrating an operation of the conventional RSC mode;

FIG. 2 is a diagram for illustrating an RSC mode control method for paging in a mobile communication system according to an exemplary embodiment of the present invention;

FIG. 3 is a diagram illustrating a configuration of a mobile communication system to which an RSC mode control method for paging according to an exemplary embodiment of the present invention is applied;

FIG. 4 is a flowchart for illustrating an RSC mode control method according to one aspect of an exemplary embodiment of the present invention;

FIG. 5 is a diagram for illustrating a method of determining a parameter value of a distribution function of a call inter-arrival time according to an exemplary embodiment of the present invention;

FIG. 6 is a diagram for illustrating a method of determining a parameter value compared with an accumulated distribution function of a call inter-arrival time according to an exemplary embodiment of the present invention;

FIG. 7 is a flowchart for illustrating an RSC mode control method according to another aspect of an exemplary embodiment of the present invention;

FIG. 8 is a signaling diagram illustrating a message transmission method between a mobile station and a base station when the mobile station releases a traffic channel and requests an RSC mode operation according to another aspect of an exemplary embodiment of the present invention;

FIG. 9 is a signaling diagram illustrating a message transmission method between a mobile station and a base station when the mobile station releases a traffic channel and the base station requests an RSC mode operation according to another aspect of an exemplary embodiment of the present invention;

FIG. 10 is a signaling diagram illustrating a message transmission method between a mobile station and a base station when the base station releases a traffic channel and the mobile station requests the RSC mode operation according to another aspect of an exemplary embodiment of the present invention;

FIG. 11 is a signaling diagram illustrating a message transmission method between a mobile station and a base station when the base station releases the traffic channel and requests the RSC mode operation according to another aspect of an exemplary embodiment of the present invention;

FIG. 12 is a block diagram illustrating a structure of a base station in a mobile communication system, to which an RSC mode control method for paging according to an exemplary embodiment of the present invention is applied;

FIG. 13 is a block diagram illustrating a structure of a mobile station in a mobile communication system, to which an RSC mode control method for paging according to an exemplary embodiment of the present invention is applied;

FIGS. 14 and 15 are diagrams illustrating an RSC mode control method using the number of SCI steps according to one aspect of exemplary embodiments of the present invention; and

FIG. 16 is a diagram illustrating an RSC mode control method using an operation time fraction of an initial SCI according to anther aspect of exemplary embodiments of the present invention.

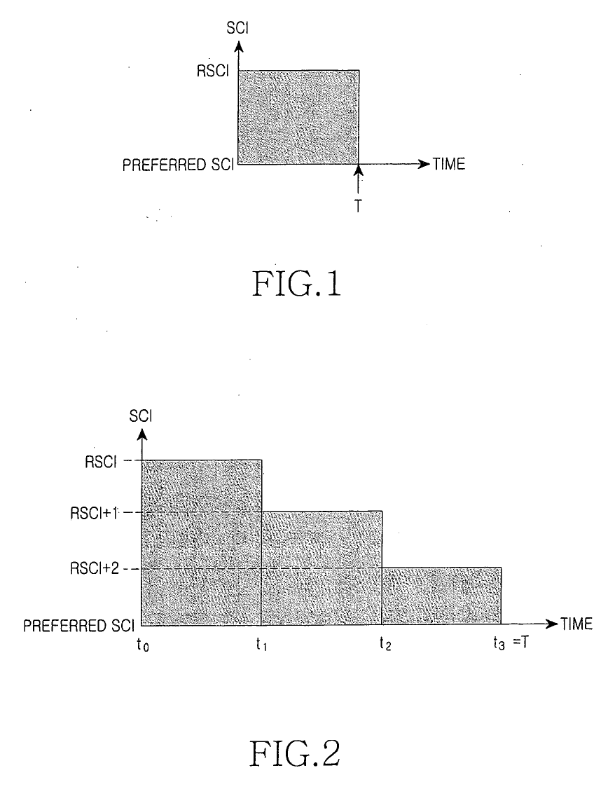

Throughout the drawings, like reference numerals will be understood to refer to like parts, components and structures.

### DETAILED DESCRIPTION OF THE EXEMPLARY EMBODIMENTS

Several exemplary embodiments of the present invention will now be described in detail with reference to the annexed drawings. In the following description, a detailed description of known functions and configurations incorporated herein has been omitted for clarity and conciseness.

A number of basic concepts applicable to exemplary embodiments of the present invention will first be described. It is well known from teletraffic theory to those skilled in the art, that distribution of a call inter-arrival time follows exponential distribution. The RSC mode introduced in CDMA2000 Rev. D is also proposed because there is high probability that a next call will be connected within a predetermined time after the current call ends.

However, when the call inter-arrival time distribution is taken into account, the conventional technology is not an optimized method in terms of power consumption of a mobile station or in terms of a time delay occurring when a base station transmits a message to a mobile station. Therefore, embodiments of the present invention preferably change SCIs of the mobile station and the base station step by step, taking the call inter-arrival time distribution into account, so as to reduce an average transmission time required when the base station transmits a message to the mobile station or to reduce power consumption of the mobile station. In addition, embodiments of the present invention propose a method and apparatus for preferably changing the SCI step by step in a method of proceeding from an RSCI to a preferred SCI at each of a predetermined time unlike in the conventional method, when the mobile station and the base station operate in the RSC mode.

FIG. 2 is a diagram for illustrating an RSC mode control method for paging in a mobile communication system according to an exemplary embodiment of the present invention. In FIG. 2, the X-axis is a time axis, and the Y-axis represents an SCI where a mobile station operates. It is assumed in FIG. 2 for example, that as the Y-axis increases, the SCI value decreases. In FIG. 2, the mobile station starts an RSC mode operation at time to, sets an SCI to an RSCI for an initial operation period (t₀˜t₁), and sets the SCI to an RSCI+1 for a second operation period (t₁˜t₂).

Thereafter, for a third operation period (t₂˜t₃), the mobile station sets the SCI to an RSCI+2. After time t₃, the mobile station terminates the RSC mode operation and operates with a preferred SCI. FIG. 2 is an example of the preferred SCI=RSCI+3. In practice, the RSCI and the preferred SCI are subject to change according to an RSCI allocation or setting method of the mobile station or the base station. Also, time tₓ (x=1, 2, 3, . . . ) at which the SCI value increases step by step is subject to change, thereby causing a change in the total operation time T.

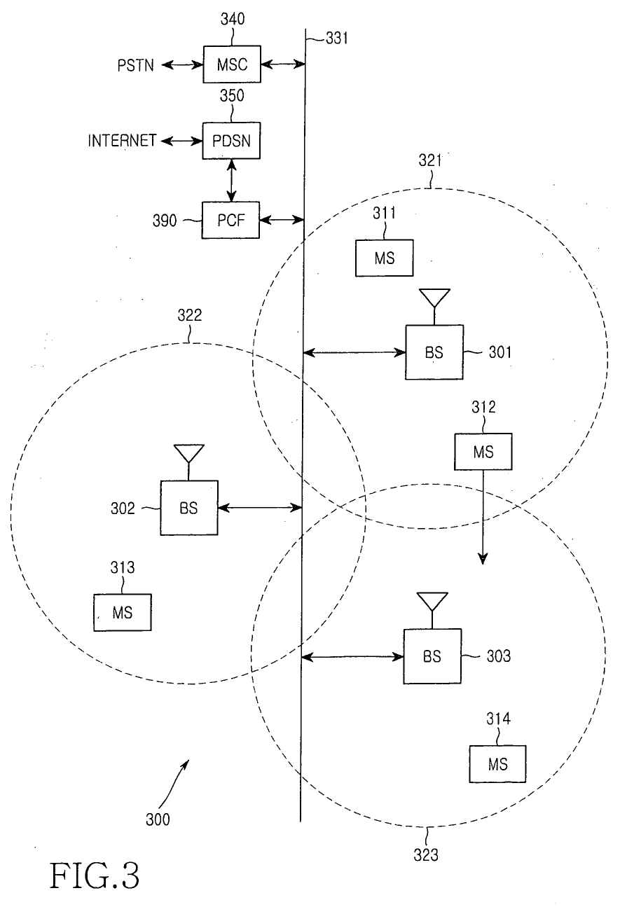

FIG. 3 is a diagram illustrating a configuration of a mobile communication system to which an RSC mode control method for paging according to an exemplary embodiment of the present invention is applied.

Referring to FIG. 3, a mobile communication system 300 comprises a plurality of cells 321 to 323, and each cell comprises one of a plurality of base stations (BSs) 301 to 303. The base stations 301 to 303 communicate with a plurality of mobile stations (MSs) 311 to 314 by, for example, CDMA technology. The mobile stations 311 to 314 can perform data communication and/or voice communication through traffic channels. The mobile stations 311 to 314 can further communicate with the base stations 301 to 303 via radio links, while moving between the cells 321 to 323. The mobile stations 311 to 314 can each be comprised of a wireless device such as a cellular phone, PCS, PDA, personal computer (PC), remote measurement device, and so forth.

In embodiments of the present invention, the mobile stations 311 to 314 are not limited to the portable devices shown, but can be comprised of other wireless access terminals including fixed-type wireless terminals and so forth. In FIG. 3, dotted circles represent approximate boundaries of the cells 321 to 323 wherein the base stations 301 to 303 are located, respectively. Each of the cells 321 to 323 is comprised of a plurality of sectors, and an antenna coupled to each base station covers the sectors. However, the mobile communication system according to embodiments of the present invention is not limited to a specific cell configuration as shown. Although each of the base stations 301 to 303 is comprised of a base station controller (BSC) and a base transceiver station (BTS), the BSC and the BTS of each are collectively expressed as a base station BS for clarity and convenience for illustration purposes.

The base stations 301 to 303 exchange voice and data signals with each other through a communication line 331 and a mobile switching center (MSC) 340 connected to a public switched telephone network (PSTN). In addition, the base stations 301 to 303 access a packet network such as the Internet, via the communication line 331 and a packet data service node (PDSN) 350 to exchange data signals such as packet data with the packet network. A packet control function (PCF) 390 controls a flow of data packets between the base stations 301 to 303 and the PDSN 350.

In the mobile communication system 300, the mobile stations 311 to 314 and the base stations 301 to 303 according to first to eighth exemplary embodiments of the present invention exchange the RO message, the ERM message, the ERRM message and the FCSO message, including the RSCI value requested by the mobile station/base station and RSC mode operation time information, separately in one case where the RSC mode operation is requested by the mobile station/base station in the traffic channel state and another case where the RSC mode operation is requested by the mobile station/base station in the idle state. If the total time for which the mobile station maintains the RSC mode before it operates with the preferred SCI is denoted by T, the T value is determined according to the RSC mode operation time information transmitted through the foregoing messages.

Each of the exemplary embodiments of the present invention proposes various methods in which a mobile station calculates a time value t (hereinafter referred to as “per-SCI operation time”) used for determining an operation period for each SCI that increases step by step as shown in FIG. 2, within the time indicated by the value T, and also proposes a new format of the messages exchanged between the base station and the mobile station for determining the value t. In this regard, the first to sixth exemplary embodiments according to one aspect of the present invention will set the per-SCI operation time for each operation period equally. In the seventh exemplary embodiment according to another aspect of the present invention, operation times of the first operation period and the last operation period are each given according to a specific fraction in the per-SCI operation time, and the operation times of the other operation periods are set equally. The eighth exemplary embodiment according to yet another aspect of the present invention sets the per-SCI operation time for the operation periods differently.

The first exemplary embodiment of the present invention proposes an algorithm for calculating a value t at which the per-SCI operation time becomes equal and its energy consumption is equal to that in the conventional RSC mode. The second exemplary embodiment proposes an algorithm for calculating a value t at which the per-SCI operation time becomes equal and its operation time is equal to that of the conventional RSC mode. The third and fourth exemplary embodiments propose an algorithm for calculating a value t for each SCI using a predetermined parameter used for determining a probability distribution function (PDF) of the call inter-arrival time. The fifth exemplary embodiment proposes an algorithm for setting a value t of each SCI to a multiple of a slot cycle length of a corresponding SCI. The sixth exemplary embodiment proposes an algorithm for setting the per-SCI operation time t using an operation time T of the RSC mode and the number n of operation steps of the RSC mode. The seventh exemplary embodiment proposes an algorithm for calculating the per-SCI operation time t using the total operation time T of the RSC mode, the number n of operation steps of the RSC mode, and a fraction parameter of the per-SCI operation time t. Finally, the eighth exemplary embodiment proposes an algorithm using a different per-SCI operation time t for each individual SCI operation period.

According to the first to eighth exemplary embodiments, it is possible to reduce an idle time required while a message is transmitted from a base station to a mobile station with the same energy as that used in the conventional RSC mode, or to use less energy for the same time and similar performance.

A detailed description will now be made of the first to eighth exemplary embodiments of the present invention.

### First Exemplary Embodiment of the Present Invention

The first embodiment proposes an improved RSC mode control method in which a per-SCI operation time is constant (t=tₙ−tₙ₋₁, n=1, 2, 3, . . . ), and its energy consumption is equal to the energy consumed when the conventional RSC mode observes the F-PCH or the F-CCCH for an RSC mode operation time T (wherein T indicates a time from an RSC mode start time until an RSC mode end time represented by RSC_END_TIME_UNIT and RSC_END_TIME_VALUE).

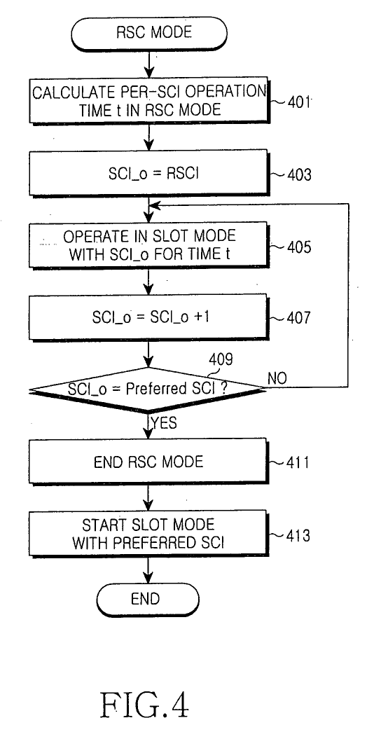

FIG. 4 is a flowchart illustrating an RSC mode control method according to one aspect of an embodiment of the present invention. Once the RSC mode operation starts, a mobile station calculates a per-SCI operation time t in step 401 using a value T requested by itself or provided from a base station. In embodiments according to one aspect of the present invention, it is assumed for example, that an operation time tₙ for each SCI is fixed to the per-SCI operation time t (tₙ=t). In step 403, the mobile station sets an SCI_o, which is a parameter in which an SCI is stored, to its initial value of RSCI. In step 405, the mobile station performs a slot mode operation with the SCI_o for the time t calculated in step 401.

Thereafter, in step 407, the mobile station increases the parameter SCI_o by 1 after a lapse of the time t. In step 409, the mobile station compares the increased SCI_o with its preferred SCI. If the two values are equal to each other, the mobile station terminates the RSC mode operation in step 411. Otherwise, if the two values are different from each other, the mobile station returns to step 405 where it repeats the slot mode operation with the increased SCI_o for the time t. The mobile station repeats the operation of steps 405 through 409 until the SCI_o becomes equal to the preferred SCI, and when the two values become equal to each other, the mobile station terminates the RSC mode operation. Thereafter, in step 413, the mobile station resumes the slot mode operation with the preferred SCI.

A detailed description will now be made of a parameter and a message format preferably required for performing an operation of the first embodiment.

In the first embodiment of the present invention, when the mobile station or the base station transmits a value T as a parameter through a message, a per-SCI operation time t is calculated by Equation (2) below.

$$t = \frac{T}{2 - {( \frac{1}{2} )}^{preferred SCI - RSCI - 1}} \qquad ( 2 )$$

In Equation (2), T denotes an RSC mode operation time, ‘preferred SCI’ denotes an SCI value used in a normal idle state in which the mobile station does not operate in an RSC mode, and RSCI denotes an initial SCI value used when the RSC mode operation starts.

In the first embodiment, the messages exchanged between the mobile station and the base station for transmission of the value T are defined as illustrated in Table 4 to Table 8. In order to simultaneously operate the conventional RSC mode and the new RSC mode proposed in accordance with the first embodiment of the present invention, the mobile station and the base station preferably must inform each other which RSC mode they will use. Therefore, there is a need for an exchange of the newly defined messages according to a state of the mobile station and the subject of requesting the RSC mode operation as reflected by the following four Cases 1-1 to 1-4.

First Case 1-4: The Mobile Station Requests RSC Mode Operation While Releasing Traffic Channel in Accordance with the First Embodiment of the Present Invention

Table 4 below illustrates by way of example a part of a data format of an RO message transmitted to a base station when a mobile station releases a traffic channel.

TABLE 4

| | |
|---|---|
| RSC_MODE_IND | 1 |
| RSCI | 0 or 4 |
| RSC_END_TIME_UNIT | 0 or 2 |
| RSC_END_TIME_VALUE | 0 or 4 |
| RSC_OP_MODE | 0 or 1 |

In Table 4, the remaining fields, except for an RSC operation mode (RSC_OP_MODE) field, are equal in function to those in the conventional RSC mode. If a 1-bit RSC_MODE_IND field in Table 4 is set to ‘1’, it indicates that the mobile station informs the base station that it will operate in the RSC mode. If the RSC_MODE_IND field is set to ‘0’, it indicates that there is no request for the RSC mode operation. The RSCI field is added when the RSC_MODE_IND field is set to ‘1’. However, when the RSC_MODE_IND field is set to ‘0’, the RSCI field is omitted and an SCI value desired by the mobile station is carried thereon instead. Herein, the SCI value is set to be less than the preferred SCI value, and its specific value is determined with reference to Table 1.

The RSC_END_TIME_UNIT field is added when the RSC_MODE_IND field is set to ‘1’, and is omitted when the RSC_MODE_IND field is set to ‘0’. The RSC_MODE_IND field is set as shown by way of example in Table 5 below.

TABLE 5

| Field (binary) | Description |
|---|---|
| 00 | Unit is 4 seconds |
| 01 | Unit is 20 seconds |
| 10 | Unit is 100 seconds |
| 11 | RESERVED |

The RSC_END_TIME_VALUE field in Table 4 is added when the RSC_MODE_IND field is set to ‘1’, and is omitted when the RSC_MODE_IND field is set to ‘0’. The mobile station writes a system time at which it will terminate the RSC mode operation, in this field per RSC_END_TIME_UNIT, after a modulo-16 operation. The RSC_OP_MODE field in Table 4 is added when the RSC_MODE_IND field is set to ‘1’, and is omitted when the RSC_MODE _IND field is set to ‘0’. If this field is set to ‘0’, the mobile station operates in the conventional RSC mode, and if this field is set to ‘1’, the mobile station operates in the new RSC mode proposed in accordance with the first embodiment of the present invention.

When the base station requests the RSC mode operation through an ERM message, the mobile station can transmit an ERRM message to the base station in response to the ERM message. In this case, the ERRM message also includes the same fields as the RO message fields shown in Table 4.

Second Case 1-2: The Base Station Requests RSC Mode Operation While Releasing Traffic Channel in Accordance with the First Embodiment of the Present Invention

To request a mobile station for an RSC mode operation while releasing a traffic channel, a base station transmits an ERM message to the mobile station. In this case, the ERM message includes the fields shown by way of example in Table 6 below.

TABLE 6

| | |
|---|---|
| RSC_MODE_SUPPORTED | 1 |
| MAX_RSC_END_TIME_UNIT | 0 or 2 |
| MAX_RSC_END_TIME_VALUE | 0 or 4 |
| REQ_RSCI_INCL | 0 or 1 |
| REQ_RSCI | 0 or 4 |
| RSC_OP_MODE | 0 or 1 |

In Table 6, if the RSC_MODE_SUPPORTED field is set to ‘1’, it indicates that the base station supports the RSC mode for the mobile station. However, if the RSC_MODE_SUPPORTED field is set to ‘0’, it indicates that the base station does not support the RSC mode. The MAX_RSC_END_TIME_UNIT field is added when the RSC_MODE_SUPPORTED field is set to ‘1’, and is omitted when the RSC_MODE_SUPPORTED field is set to ‘0’. A maximum value of the RSC_END_TIME_UNIT field for determining an RSC mode operation time of a mobile station is determined according to the MAX_RSC_END_TIME_UNIT field, and this value is set according to Table 5.

The MAX_RSC_END_TIME_VALUE field is added when the RSC_MODE_SUPPORTED field is set to ‘1’, and is omitted when the RSC_MODE_SUPPORTED field is set to ‘0’. The base station determines this field value as a maximum value of a system time at which the mobile station terminates the RSC mode operation, per RSC_END_TIME_UNIT, and this value undergoes a modulo-16 operation.

Further, a REQ_RSCI_INCL field in Table 6 is added when the RSC_MODE_SUPPORTED field is set to ‘1’, and is omitted when the RSC_MODE_SUPPORTED field is set to ‘0’. To request the mobile station for the RSC mode operation, the base station sets this field to ‘1’ and includes a REQ_RSCI field in the ERM message before transmission of the ERM message. The REQ_RSCI field is included when the REQ_RSCI_INCL field is set to ‘1’, and a value of this field is set according to Table 1. However, this field is omitted when the REQ_RSCI_INCL field is set to ‘0’. The RSC_OP_MODE field is added when the REQ_RSCI_INCL field is set to ‘1’, and is omitted when the REQ_RSCI_INCL field is set to ‘0’. If this field is set to ‘0’, the mobile station operates in the conventional RSC mode, and if this field is set to ‘1’, the mobile station operates in the new RSC mode proposed in accordance with the first embodiment of the present invention. In addition, the base station sets the REQ_RSCI_INCL field to ‘0’ when it uses the ERM message as a response to the RO message transmitted by the mobile station.

Third Case 1-3: The Mobile Station Requests RSC Mode Operation in Idle State in Accordance with the First Embodiment of the Present Invention

To request a base station for an RSC mode operation in the idle state, a mobile station can transmit an FCSO message, shown by way of example in Table 7 below, to the base station.

TABLE 7

| | |
|---|---|
| ORDQ | 8 |
| RSC_MODE_IND | 1 |
| RSCI | 0 or 4 |
| RSC_END_TIME_UNIT | 0 or 2 |
| RSC_END_TIME_VALUE | 0 or 4 |
| RSC_OP_MODE | 0 or 1 |

Most of the fields in Table 7 are equal to the fields of the RO message except for the following ORDQ field, and a description thereof will be provided below. If the ORDQ field is set to ‘00000000’, it indicates that the mobile station requests the base station for the RSC mode operation. If the ORDQ field is set to ‘00000001’, it indicates that the mobile station responds to the FCSO message transmitted by the base station.

Fourth Case 1-4: The Base Station Requests RSC Mode Operation in Idle State in Accordance with the First Embodiment of the Present Invention

To request a mobile station for an RSC mode operation in the idle state, a base station can transmit an FCSO message with a different format, shown by way of example in Table 8 below, to the mobile station.

TABLE 8

| | |
|---|---|
| ORDQ | 8 |
| RSC_MODE_SUPPORTED | 1 |
| MAX_RSC_END_TIME_UNIT | 0 or 2 |
| MAX_RSC_END_TIME_VALUE | 0 or 4 |
| REQ_RSCI | 0 or 4 |
| RSC_OP_MODE | 0 or 1 |

Most of the fields in Table 8 are equal to the fields of the ERM message except for the following ORDQ fields, and a description thereof will be provided below. If the ORDQ field is set to ‘00000000’, it indicates that the base station requests the mobile station for the RSC mode operation. If the ORDQ field is set to ‘00000001’, it indicates that the base station responds to the FCSO message transmitted by the mobile station.

The REQ_RSCI field in Table 8 is added only when the ORDQ field is set to ‘00000000’ and the RSC_MODE_SUPPORTED field is set to ‘1’. Otherwise, the REQ_RSCI field is omitted. The base station sets an SCI value for requesting the mobile station to operate in the RSC mode. Similarly, the RSC_OP_MODE field is included only when the ORDQ field is set to ‘00000000’ and the RSC_MODE_SUPPORTED field is set to ‘1’. Otherwise, the RSC_OP_MODE field is omitted. If a value of this field is ‘0’, it indicates that the base station requests the conventional RSC mode operation, and if the value of this field is ‘1’, it indicates that the base station requests the new RSC mode operation proposed in accordance with the first embodiment of the present invention.

### Second Exemplary Embodiment of the Present Invention

The second embodiment of the present invention proposes an improved RSC mode operated for a time T, assuming for example, that it terminates the RSC mode after operating for the time T using an RSCI as an SCI in the conventional RSC mode, and then performs a slot mode operation with a preferred SCI value. A basic operation of the second embodiment of the present invention substantially follows the method of FIG. 4, and the messages exchanged between the mobile station and the base station are substantially equal to those described in the first embodiment of the present invention, therefore a detailed description thereof will be omitted for simplicity. A difference between the second embodiment and the first embodiment lies in the method for calculating the per-SCI operation time t.

In the second embodiment of the present invention, if the mobile station or the base station transmits the value T as a parameter through a message, a per-SCI operation time t is calculated by Equation (3) below.

$$t = \frac{T}{preferred SCI - RSCI} \qquad ( 3 )$$

In Equation (3), all of the parameters are equal to those described in connection with Equation (2), and the RO message, the ERM message, the ERRM message and the FCSO message exchanged between the mobile station and the base station can also be equal to those applied in the first embodiment of the present invention.

### Third Exemplary Embodiment of the Present Invention

In the third embodiment of the present invention, an RSC mode operation increases in an SCI step by step for each of a predetermined time, taking into account the fact that a probability distribution function (PDF) of a call inter-arrival time is an exponential function. The PDF of the call inter-arrival time can be expressed as a function of a parameter α as shown in Equation (4) below. The PDF of Equation (4) is characterized in that when integrated from zero to infinity, it becomes ‘1’.
pdf(t)=α×e^{-αt} (4)

That is, the third embodiment of the present invention proposes a method for maintaining the RSC mode operation until a time T for which an integrated value of the PDF expressed as Equation (4) becomes greater than or equal to β(0<β<1). The basic operation of the third embodiment of the present invention follows the method of FIG. 4, and is equal to that described in the first embodiment of the present invention. A difference between the third embodiment and the first embodiment lies in the method for calculating the per-SCI operation time t.

In the third embodiment of the present invention, parameters transmitted through a message by the mobile station or the base station to calculate a value t of the mobile station can include the value T, or the values α and β applied to the PDF. Alternatively, the third embodiment of the present invention can directly transmit the value t through the message.

A detailed description will now be made of the third embodiment of the present invention separately for the following three Cases 3-1 to 3-3, according to the type of parameters carried on the message.

Case 3-1: Parameter T is Carried on Message of Mobile Station or Base Station in Accordance with the Third Embodiment of the Present Invention

In this case, the per-SCI operation time t described in the first embodiment of the present invention in accordance with Equation (3) is used, and all of the parameters in Equation (3) are equal to those described in connection with Equation (2). The RO message, the ERM message, the ERRM message and the FCSO message exchanged between the mobile station and the base station can also be equal to those applied in the first embodiment of the present invention.

Case 3-2: Parameters α and β are Carried on Message of Mobile Station or Base Station in Accordance with the Third Embodiment of the Present Invention

In this case, the per-SCI operation time t is calculated by Equation (5) below.

$$t = \frac{ln ( 1 - β )}{α ( RSCI - preferred SCI} \qquad ( 5 )$$

In Equation (5), α denotes a parameter of the PDF (see Equation (4)) indicating a call inter-arrival time, β denotes an accumulated distribution function of the call inter-arrival time corresponding to the RSC mode operation time, and ln( ) denotes a natural logarithm function. In this case, the messages exchanged between the base station and the mobile station for transmission of the values α and β are defined as illustrated in Table 9 through Table 12.

A detailed description will now be made of a format of the messages separately for the following four Cases 3-2(1) to 3-2(4), divided from Case 3-2 according to the status of the mobile station and the subject of requesting the RSC mode operation.

First Case 3-2(1): Mobile Station Requests RSC Mode Operation while Releasing Traffic Channel in Accordance with the Third Embodiment of the Present Invention

Table 9 below illustrates by way of example a partial format of the RO message transmitted from the mobile station to the base station when the mobile station releases the traffic channel.

TABLE 9

| | |
|---|---|
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_EXPO_A | 0 or 10 |
| RSC_BETA | 0 or 10 |

In Table 9, if the 1-bit RSC_MODE_IND field is set to ‘1’, it indicates that the mobile station informs the base station that it will operate in the RSC mode. If the RSC_MODE_IND field is set to ‘0’, it indicates that there is no need to operate in the RSC mode. The RSCI field is added when the RSC_MODE_IND field is set to ‘1’, and is omitted when the RSC_MODE_IND field is set to ‘0’. The RSCI field carries an RSCI value desired by the mobile station, and its value is determined with reference to Table 1.

The RSC_OP_MODE field is added when the RSC_MODE_IND field is set to ‘1’, and is omitted when the RSC_MODE_IND field is set to ‘0’. If this field is set to ‘0’, the mobile station operates in the conventional RSC mode, and if this field is set to ‘1’, the mobile station operates in the new RSC mode proposed in accordance with the third embodiment of the present invention. The RSC_END_TIME_UNIT field is added when the RSC_OP_MODE field is set to ‘0’, and is omitted when the RSC_OP_MODE field is set to ‘1’. A value of the RSC_END_TIME_UNIT field is set using Table 5. The RSC_END_TIME_VALUE field is added when the RSC_OP_MODE field is set to ‘0’, and is omitted when the RSC_OP_MODE field is set to ‘1’. The mobile station writes a system time at which it will terminate the RSC mode operation, in this field per RSC_END_TIME_UNIT, after a modulo-16 operation.

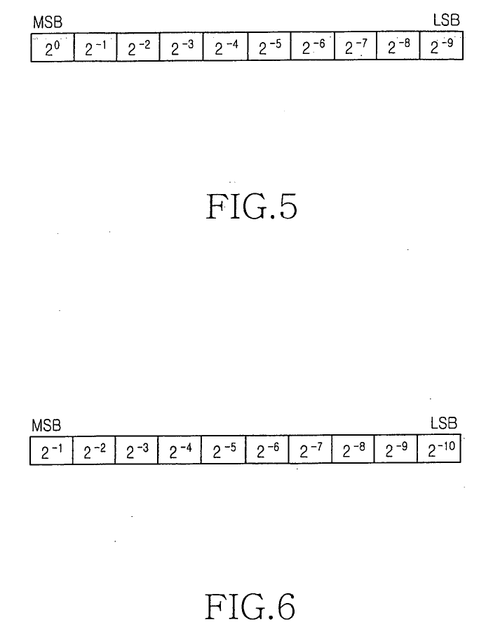

An RSC_EXPO_A field is omitted when the RSC_OP_MODE field is set to ‘0’. However, when the RSC_OP_MODE field is set to ‘1’, the RSC_EXPO_A field is included in the message, setting a value of a parameter α for the call inter-arrival time distribution function. The field value is set according to FIG. 5 that illustrates a format of the RSC_EXPO_A field. In FIG. 5, the MSB denotes the most significant bit of this field value and the LSB denotes the least significant bit. A real number of the entire field is determined by the sum of bit values of the digits having a value of ‘1’. For example, in order to set the field value to 0.75, the RSC_EXPO_A field is set to ‘01 10000000’.

An RSC_BETA field is omitted when the RSC_OP_MODE field is set to ‘0’. However, when the RSC_OP_MODE field is set to ‘1’, the RSC_BETA field is included in the message, setting a value of a parameter β for the call inter-arrival time distribution function. The RSC mode operation proposed in accordance with the third embodiment of the present invention continues until the accumulated distribution function of the call inter-arrival time becomes greater than or equal to a value of the RSC_BETA field. Similarly, a real number of the RSC_BETA field is determined by the sum of bit values of the digits having a value of ‘1’. The bit values of the digits are determined according to FIG. 6 that illustrates a format of the RSC_BETA field.

When the base station requests the RSC mode operation through an ERM message, the mobile station can transmit an ERRM message to the base station in response to the ERM message. In this case, the fields included in the ERRM message are equal to the fields of the RO message shown in Table 9.

Second Case 3-2(2): Base Station Requests RSC Mode Operation while Releasing Traffic Channel in Accordance with the Third Embodiment of the Present Invention

A base station transmits an ERM message in order to request a mobile station for an RSC mode operation while releasing a traffic channel. The ERM message includes the fields shown by way of example in Table 10 below.

TABLE 10

| | |
|---|---|
| RSC_MODE_SUPPORTED | 1 |
| REQ_RSCI_INCL | 0 or 1 |
| REQ_RSCI | 0 or 4 |
| RESPOND_IND | 0 or 1 |
| RSC_OP_MODE | 0 or 1 |
| MAX_RSC_END_TIME_UNIT | 0 or 2 |
| MAX_RSC_END_TIME_VALUE | 0 or 4 |
| MIN_RSC_EXPO_A | 0 or 10 |
| MAX_RSC_BETA | 0 or 10 |

In Table 10, if the RSC_MODE_SUPPORTED field is set to ‘1’, it indicates that the base station supports the RSC mode for the mobile station. However, if its field value is set to ‘0’, it indicates that the base station does not support the RSC mode.

The REQ_RSCI_INCL field is added when the RSC_MODE_SUPPORTED field is set to ‘1’, and is omitted when the RSC_MODE_SUPPORTED field is set to ‘0’. If the base station requests the mobile station for the RSC mode operation, it sets this field to ‘1’. Otherwise, the base station sets this field to ‘0’. The REQ_RSCI_INCL field is set to ‘0’ when the base station uses the ERM message as a response to the RO message transmitted by the mobile station.

The REQ_RSCI field is included in the message when the REQ_RSCI_INCL field is set to ‘1’, and its field value is set according to Table 1. However, this field is omitted when the REQ_RSCI_INCL field is set to ‘0’.

A RESPOND_IND field is omitted when the REQ_RSCI_INCL field is set to ‘1’. Otherwise, this field is added to the message, and its value is set in the following manner. If the ERM message is transmitted as a response to a request for the RSC mode operation through the RO message from the mobile station, this field is set to ‘1’. Otherwise, this field is set to ‘0’. The RSC_OP_MODE field is added when the REQ_RSCI_INCL field is set to ‘1’ or when the RESPOND_IND field is added and its field value is set to ‘1’. Otherwise, the RSC_OP_MODE field is omitted. If the RSC_OP_MODE field is set to ‘0’, it indicates that the base station operates in the conventional RSC mode. However, if the RSC_OP_MODE field is set to ‘1’, it indicates that the base station operates in the new RSC mode proposed in accordance with the third embodiment of the present invention.

The MAX_RSC_END_TIME_UNIT field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_UNIT field is omitted. A value of the MAX_RSC_END_TIME_UNIT field is set according to Table 5.

The MAX_RSC_END_TIME_VALUE field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_VALUE field is omitted. The base station writes a system time at which the mobile station will terminate the RSC mode operation, in the MAX_RSC_END_TIME_VALUE field per RSC_END_TIME_UNIT, after a modulo-16 operation.

A MIN_RSC_EXPO_A field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘1’. Otherwise, the MIN_RSC_EXPO_A field is omitted. The MIN_RSC_EXPO_A field is used for setting a minimum value of a parameter α for the call inter-arrival time distribution function, and its setting method follows FIG. 5.

A MAX_RSC_BETA field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘1’. Otherwise, the MAX RSC_BETA field is omitted. The RSC mode operation of the mobile station continues until the accumulated distribution function of the call inter-arrival time becomes greater than or equal to β. A possible maximum value of the β and its setting method follow FIG. 6.

Third Case 3-2(3): Mobile Station Requests RSC Mode Operation in Idle State in Accordance with the Third Embodiment of the Present Invention

A mobile station can transmit an FCSO message as shown by way of

example in Table 11 below, in order to request a base station for the RSC mode operation in the idle state.

TABLE 11

| | |
|---|---|
| ORDQ | 8 |
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_EXPO_A | 0 or 10 |
| RSC_BETA | 0 or 10 |

Most of the fields in Table 11 are equal to the fields of the RO message shown in Table 4 except for the following ORDQ field, and a description thereof will be provided below. If the ORDQ field is set to ‘00000000’, it indicates that the mobile station requests the base station for the RSC mode operation. If the ORDQ field is set to ‘00000001’, it indicates that the mobile station responds to the FCSO message transmitted by the base station.

Fourth Case 3-2(4): Base Station Requests RSC Mode Operation in Idle State in Accordance with the Third Embodiment of the Present Invention

A base station can transmit an FCSO message as shown by way of example in Table 12 below, in order to request a mobile station for the RSC mode operation in the idle state.

TABLE 12

| | |
|---|---|
| ORDQ | 8 |
| RSC_MODE_SUPPORTED | 1 |
| REQ_RSCI | 0 or 4 |
| RSC_OP_MODE | 0 or 1 |
| MAX_RSC_END_TIME_UNIT | 0 or 2 |
| MAX_RSC_END_TIME_VALUE | 0 or 4 |
| MIN_RSC_EXPO_A | 0 or 10 |
| MAX_RSC_BETA | 0 or 10 |

Most of the fields in Table 12 are equal to the fields of the ERM message shown in Table 6 except for the following ORDQ fields, and a description thereof will be provided below. If the ORDQ field is set to ‘00000000’, it indicates that the base station requests the mobile station for the RSC mode operation. If the ORDQ field is set to ‘00000001’, it indicates that the base station responds to the FCSO message transmitted by the mobile station.

The REQ_RSCI field is included only when the ORDQ field is set to ‘00000000’ and the RSC_MODE_SUPPORTED field is set to ‘1’. Otherwise, the REQ_RSCI field is omitted. The REQ_RSCI field is used for setting an SCI value for requesting the mobile station to operate in the RSC mode.

The base station sets the RSC_OP_MODE field to ‘0’ to request the conventional RSC mode, and sets the RSC_OP_MODE field to ‘1’ to request the new RSC mode proposed in accordance with the third embodiment of the present invention.

The MAX_RSC_END_TIME_UNIT field is added when the ORDQ field is set to ‘00000000’ or when the ORDQ field is set to ‘00000001’ and the RSC_OP_MODE field is set to ‘0’. Otherwise, the MAX_RSC_END_TIME_UNIT field is omitted. A value of the MAX_RSC_END_TIME_UNIT field is set according to Table 5.

The MAX_RSC_END_TIME_VALUE field is added when the ORDQ field is set to ‘00000000’ or when the ORDQ field is set to ‘00000001’ and a value of the RSC_OP_MODE field is set to ‘0’. Otherwise, the MAX_RSC_END_TIME_VALUE field is omitted. The base station writes a system time at which the mobile station will terminate the RSC mode operation, in the MAX_RSC_END_TIME_VALUE field per RSC_END_TIME_UNIT, after a modulo-16 operation.

The MIN_RSC_EXPO_A field is added when the ORDQ field is set to ‘00000000’ or when the ORDQ field is set to ‘00000001’ and a value of the RSC_OP_MODE field is set to ‘1’. Otherwise, the MIN_RSC_EXPO_A field is omitted. The MIN_RSC_EXPO_A field carries a minimum value of a parameter α for the call inter-arrival time distribution function, and is set in the field format of FIG. 5 according to the method described in greater detail below.

The MAX_RSC_BETA field is added when the ORDQ field is set to ‘00000000’ or when the ORDQ field is set to ‘00000001’ and a value of the RSC_OP_MODE field is set to ‘1’. Otherwise, the MAX_RSC_BETA field is omitted. The MAX_RSC_BETA field carries a maximum value of an accumulated distribution function parameter β for the call inter-arrival time, and its setting format follows FIG. 6. The RSC mode operation of the mobile station continues until the accumulated distribution function of the call inter-arrival time arrives at β. The remaining fields herein are equal to their corresponding fields of the ERM message described above.

Case 3-3: Parameter t is Carried on Message of Mobile Station or Base Station in Accordance with the Third Embodiment of the Present Invention

In this case, an intact per-SCI operation time t received through a message is used, and a format of the message exchanged between a mobile station and a base station will be described herein separately for the following four Cases 3-3(1) to 3-3(4) according to the subjects of requesting the RSC mode.

First Case 3-3(1): Mobile Station Requests RSC Mode Operation while Releasing Traffic Channel in Accordance with the Third Embodiment of the Present Invention

Table 13 below shows by way of example a partial format of an RO message that a mobile station transmits while releasing a traffic channel. A detailed description of the fields in Table 13, used in the preceding embodiments of the present invention, will be omitted for simplicity.

TABLE 13

| | |
|---|---|
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_ONE_SCI_TIME | 0 or 13 |

In Table 13, if the 1-bit RSC_MODE_IND field is set to ‘1’, it indicates that the mobile station informs the base station that it will operate in the RSC mode. If the RSC_MODE_IND field is set to ‘0’, it indicates that there is no need to operate in the RSC mode.

The RSCI field is added when the RSC_MODE_IND field is set to ‘1’, and is omitted when the RSC_MODE_IND field is set to ‘0’. The RSCI field carries an RSCI value desired by the mobile station, and its value is determined with reference to Table 1. The RSC_OP_MODE field is added when the RSC_MODE_IND field is set to ‘1’, and is omitted when the RSC_MODE_IND field is set to ‘0’. If this field is set to ‘0’, the mobile station operates in the conventional RSC mode, and if this field is set to ‘1’, the mobile station operates in the new RSC mode proposed in accordance with the third embodiment of the present invention.

The RSC_END_TIME_UNIT field is added when the RSC_OP_MODE field is set to ‘0’, and is omitted when the RSC_OP_MODE field is set to ‘1’. A value of the RSC_END_TIME_UNIT field is set using Table 5. The RSC_END_TIME_VALUE field is added when the RSC_OP_MODE field is set to ‘0’, and is omitted when the RSC_OP_MODE field is set to ‘1’. The mobile station writes a system time at which it will terminate the RSC mode operation, in the RSC_END_TIME_VALUE field per RSC_END_TIME_UNIT, after a modulo-16 operation.

An RSC_ONE_SCI_TIME field is omitted when the RSC_OP_MODE field is set to ‘0’. However, when the RSC_OP_MODE field is set to ‘1’, the RSC_ONE_SCI_TIME field is included, setting a per-SCI operation time. The per-SCI operation time is set to an 80 ms-based value. If the base station requests the RSC mode operation through an ERM message, the mobile station can transmit an ERRM message in response thereto, and this message also includes the same fields as those of the RO message.

Second Case 3-3(2): Base Station Requests RSC Mode Operation while Releasing Traffic Channel in Accordance with the Third Embodiment of the Present Invention

A base station transmits an ERM message in order to request a mobile station for an RSC mode operation while releasing a traffic channel. The ERM message includes the fields shown by way of example in Table 14 below.

TABLE 14

| | |
|---|---|
| RSC_MODE_SUPPORTED | 1 |
| REQ_RSCI_INCL | 0 or 1 |
| REQ_RSCI | 0 or 4 |
| RESPOND_IND | 0 or 1 |
| RSC_OP_MODE | 0 or 1 |
| MAX_RSC_END_TIME_UNIT | 0 or 2 |
| MAX_RSC_END_TIME_VALUE | 0 or 4 |
| MAX_RSC_ONE_SCI_TIME | 0 or 13 |

In Table 14, if the RSC_MODE_SUPPORTED field is set to ‘1’, it indicates that the base station supports the RSC mode for the mobile station. However, if its field value is set to ‘0’, it indicates that the base station does not support the RSC mode.

The REQ_RSCI_INCL field is added when the RSC_MODE_SUPPORTED field is set to ‘1’, and is omitted when the RSC_MODE_SUPPORTED field is set to ‘0’. If the base station requests the mobile station for the RSC mode operation, it sets this field to ‘1’ and includes the REQ_RSCI field in the message. Otherwise, the base station sets this field to ‘0’. The REQ_RSCI field is included in the message when the REQ_RSCI_INCL field is set to ‘1’, and its field value is set according to Table 1. However, this field is omitted when the REQ_RSCI_INCL field is set to ‘0’.

The RESPOND_IND field is omitted when the REQ_RSCI_INCL field is set to ‘1’. Otherwise, the RESPOND_IND field is added to the message, and its value is set in the following manner. If the ERM message is transmitted as a response to a request for the RSC mode operation through the RO message from the mobile station, this field is set to ‘1’. Otherwise, this field is set to ‘0’.

The RSC_OP_MODE field is added when the REQ_RSCI_INCL field is set to ‘1’ or when the RESPOND_IND field is added and its field value is set to ‘1’. Otherwise, the RSC_OP_MODE field is omitted. If the RSC_OP_MODE field is set to ‘0’, it indicates that the base station requests the conventional RSC mode. However, if the RSC_OP_MODE field is set to ‘1’, it indicates that the base station requests the mobile station for the new RSC mode proposed in accordance with the third embodiment of the present invention.

The MAX_RSC_END_TIME_UNIT field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_UNIT field is omitted. A value of the MAX_RSC_END_TIME_UNIT field is set according to Table 5.

The MAX RSC_END_TIME_VALUE field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_VALUE field is omitted. The base station writes a system time at which the mobile station will terminate the RSC mode operation, in the MAX_RSC_END_TIME_VALUE field per RSC_END_TIME_UNIT, after a modulo-16 operation.

A MAX_RSC_ONE_SCI_TIME field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘1’. Otherwise, the MAX_RSC_ONE_SCI_TIME field is omitted. The MAX_RSC_ONE SCI_TIME field is used for setting a minimum value of the per-SCI operation time, and its field value is set to an 80 ms-based value. If the base station uses an ERM message as a response to the RO message transmitted by the mobile station, the REQ_RSCI_INCL field is set to ‘0’.

Third Case 3-3(3): Mobile Station Requests RSC Mode Operation in Idle State in Accordance with the Third Embodiment of the Present Invention

A mobile station can transmit an FCSO message as shown by way of example in Table 15 below, in order to request a base station for the RSC mode operation in the idle state.

TABLE 15

| | |
|---|---|
| ORDQ | 8 |
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_ONE_SCI_TIME | 0 or 13 |

Most of the fields in Table 15 are equal to the fields of the foregoing RO message except for the following ORDQ field, and a description thereof will be provided below. If the ORDQ field is set to ‘00000000’, it indicates that the mobile station requests the base station for the RSC mode operation. If the ORDQ field is set to ‘00000001’, it indicates that the mobile station responds to the FCSO message transmitted by the base station.

Fourth Case 3-3(4): Base Station Requests RSC Mode Operation in Idle State in Accordance with the Third Embodiment of the Present Invention

A base station can transmit an FCSO message as shown by way of example in Table 16 below, in order to request a mobile station for the RSC mode operation in the idle state.

TABLE 16

| | |
|---|---|
| ORDQ | 8 |
| RSC_MODE_SUPPORTED | 1 |
| REQ_RSCI | 0 or 4 |
| RSC_OP_MODE | 0 or 1 |
| MAX_RSC_END_TIME_UNIT | 0 or 2 |
| MAX_RSC_END_TIME_VALUE | 0 or 4 |
| MAX_RSC_ONE_SCI_TIME | 0 or 13 |

Most of the fields in Table 16 are equal to the fields of the foregoing ERM message except for the following ORDQ fields, and a description thereof will be provided below.

If the ORDQ field is set to ‘00000000’, it indicates that the base station requests the mobile station for the RSC mode operation. If the ORDQ field is set to ‘00000001’, it indicates that the base station responds to the FCSO message transmitted by the mobile station. The REQ_RSCI field is included only when the ORDQ field is set to ‘00000000’ and the RSC_MODE_SUPPORTED field is set to ‘1’. Otherwise, the REQ_RSCI field is omitted. The REQ_RSCI field is used for setting an SCI value for requesting the mobile station to operate in the RSC mode.

The base station sets the RSC_OP_MODE field to ‘0’ to request the conventional RSC mode, and sets the RSC_OP_MODE field to ‘1’ to request the new RSC mode proposed in accordance with the third embodiment of the present invention.

The MAX_RSC_END_TIME_UNIT field is added when the ORDQ field is set to ‘00000000’ or when the ORDQ field is set to ‘00000001’ and the RSC_OP_MODE field is set to ‘0’. Otherwise, the MAX_RSC_END_TIME_UNIT field is omitted. A value of the MAX_RSC_END_TIME_UNIT field is set according to Table 5.

The MAX_RSC_END_TIME_VALUE field is added when the ORDQ field is set to ‘00000000’ or when the ORDQ field is set to ‘00000001’ and a value of the RSC_OP_MODE field is set to ‘0’. Otherwise, the MAX_RSC_END_TIME_VALUE field is omitted. The base station writes a system time at which the mobile station will terminate the RSC mode operation, in the MAX_RSC_END_TIME_VALUE field per RSC_END_TIME_UNIT, after a modulo-16 operation.

The MAX_RSC_ONE_SCI_TIME field is added when the ORDQ field is set to ‘00000000’ or when the ORDQ field is set to ‘00000001’ and a value of the RSC_OP_MODE field is set to ‘1’. Otherwise, the MAX_RSC_ONE_SCI_TIME field is omitted. The MAX_RSC_ONE_SCI_TIME field is used for setting a maximum value of the per-SCI operation time, and its field value is set to an 80 ms-based value. The remaining fields herein are equal to their corresponding fields of the ERM message, described above.

### Fourth Exemplary Embodiment of the Present Invention

The fourth embodiment of the present invention proposes a method for increasing an SCI by one each time an accumulated distribution function of a call inter-arrival time becomes,

$$0.5 , 0.75 , 0.875 , … , {\sum }_{n = 1}^{k} {( \frac{1}{2} )}^{n} , … ( k = 1 , 2 , 3 , … ) ,$$

that is, each time the accumulated distribution function increases by 50% from its previous value. A distribution function of the call inter-arrival time can be expressed as a function of a parameter α as shown in Equation (4).

A basic operation of the fourth embodiment of the present invention follows the flowchart of FIG. 4, and a description thereof will be omitted herein, as it is equal to that of the first embodiment of the present invention.

A difference between the fourth embodiment and the first embodiment lies in the method for calculating the per-SCI operation time t. Equation (6) below is used for calculating the per-SCI operation time t according to the fourth embodiment of the present invention.

$$t = \frac{ln 2}{α} \qquad ( 6 )$$

In Equation (6), α denotes a parameter for a probability distribution function (see Equation (4)) of the call inter-arrival time, and ln( ) denotes a natural logarithm function.

In the fourth embodiment of the present invention, a parameter carried on a message transmitted by a mobile station or a base station to calculate the value t of the mobile station can include a value α or a value T applied to the probability distribution function. Alternatively, the fourth embodiment of the present invention can carry the intact value t through the message. The former case where the value α is transmitted as a parameter has been described above with reference to Equation (6), and its associated message transmission method is similar to the message transmission method of transmitting the values α and β, proposed in accordance with the third embodiment of the present invention. However, the fourth embodiment of the present invention is different from the preceding embodiments in that there is no β-related parameter.

Therefore, in the fourth embodiment of the present invention, the RO message and the ERRM message transmitted from the mobile station to the base station do not include the RSC_BETA field used in the third embodiment, and the ERM message transmitted from the base station to the mobile station does not include the MAX_RSC_BETA field. In addition, because the FCSO message transmitted from the mobile station to the base station does not include the RSC_BETA field, the FCSO message transmitted from the base station to the mobile station also does not include the MAX_RSC_BETA field. Another former case where the value T is transmitted as a parameter can be applied to Equation (3). In this case, the message transmission method is equal to that of the first embodiment of the present invention. The latter case where the value t is transmitted as a parameter is equal to the corresponding case of the third embodiment of the present invention.

### Fifth Exemplary Embodiment of the Present Invention

The fifth embodiment of the present invention proposes a method for setting a per-SCI operation time t to a multiple of a slot cycle length corresponding to an SCI in use. The number N_{preferredSCI-1} (hereinafter referred to as a “paging slot observation number”) of paging slots for the F-PCH or the F-CCCH, observed for a preferred SCI-1 time t, can be calculated by Equation (7) below.

$${N}_{preferred SCI - 1} = max ( 1 , round ( \frac{ln 2}{α} {f}_{preferred SCI - 1} ) ) \qquad ( 7 )$$

A basic operation of the fifth embodiment of the present invention follows the flowchart of FIG. 4, and a description thereof is equal to that of the first embodiment of the present invention. A difference between the fifth embodiment and the first embodiment lies in the method for calculating the per-SCI operation time t. In the fifth embodiment of the present invention, a parameter carried on a message transmitted by a mobile station or a base station to calculate the value t of the mobile station can include (i) a value α applied to the probability distribution function, (ii) a paging slot observation number N_{preferredSCI-1} defined as Equation (7), or (iii) the total operation time T of the RSC mode. Alternatively, the fifth embodiment of the present invention can carry the intact value t through the message.

A detailed description will now be made of the fifth embodiment of the present invention separately for three Cases 5-1 to 5-3 according to the type of the parameters carried on the message transmitted by the mobile station and the base station.

Case 5-1: Parameter α is Used in Accordance with the Fifth Embodiment of the Present Invention

The per-SCI operation time t can be calculated using Equation (8) below. This case is equal in message format to the case where per-SCI operation time t is used as the parameter in the third embodiment of the present invention.

$$t = \frac{max ( 1 , round ( \frac{ln 2}{α} {f}_{preferred SCI - 1} ) )}{{f}_{preferred SCI - 1}} \qquad ( 8 )$$

In Equation (8), α denotes a parameter for a probability distribution function (see Equation (4)) of the call inter-arrival time, ln( ) denotes a natural logarithm function, f_{preferredSCI-1} denotes a reciprocal of the slot cycle length represented by a preferred SCI-1, round( ) denotes a round-up operator used for rounding the numerator into an integer, and max(A,B) denotes a greater one of A and B. The per-SCI operation time t given using Equation (8) becomes a multiple of the slot cycle length. In Case 5-1, a format of each message distinguished according to the status of the mobile station and the subject of requesting the RSC mode operation is equal to that used in the method for transmitting the value α in the fourth embodiment.

Case 5-2: Paging Slot Observation Number N_{preferredSCI-1} is Used as a Parameter in Accordance with the Fifth Embodiment of the Present Invention

In this case, the per-SCI operation time t is defined as Equation (9) below.

$$t = \frac{{N}_{preferred SCI - 1}}{{f}_{preferred SCI - 1}} \qquad ( 9 )$$

A detailed description of a format of each message distinguished according to the status of the mobile station and the subject of requesting the RSC mode operation will now be made separately for the following four Cases 5-2(1) to 5-2(4).

First Case 5-2(1): Mobile Station Requests RSC Mode Operation while Releasing Traffic Channel in Accordance with the Fifth Embodiment of the Present Invention

Table 17 below shows by way of example a partial format of an RO message that a mobile station transmits while releasing a traffic channel. A detailed description of the fields in Table 17, used in the preceding embodiments, will be omitted for simplicity.

TABLE 17

| | |
|---|---|
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_Nx_1 | 0 or 12 |

In Table 17, if the 1-bit RSC_MODE_IND field is set to ‘1’, it indicates that the mobile station informs the base station that it will operate in the RSC mode. If the RSC_MODE_IND field is set to ‘0’, it indicates that there is no need to operate in the RSC mode.

The RSCI field is added when the RSC_MODE_IND field is set to ‘1’, and is omitted when the RSC_MODE_IND field is set to ‘0’. The RSCI field carries an SCI value desired by the mobile station, and its field value is determined with reference to Table 1.

The RSC_OP MODE field is added when the RSC_MODE_IND field is set to ‘1’, and is omitted when the RSC_MODE_IND field is set to ‘0’. If this field is set to ‘0’, the mobile station operates in the conventional RSC mode, and if this field is set to ‘1’, the mobile station operates in the new RSC mode proposed in accordance with the fifth embodiment of the present invention.

The RSC_END_TIME_UNIT field is added when the RSC_OP_MODE field is set to ‘0’, and is omitted when the RSC_OP_MODE field is set to ‘1’. A value of this field is set according to Table 5. The RSC_END_TIME_VALUE field is added when the RSC_OP_MODE field is set to ‘0’, and is omitted when the RSC_OP_MODE field is set to ‘1’. The mobile station writes a system time at which it will terminate the RSC mode operation, in the RSC_END_TIME_VALUE field per RSC_END_TIME_UNIT, after a modulo-16 operation.

An RSC_Nx_{—}1 field is omitted when the RSC_OP MODE field is set to ‘0’, and is included when the RSC_OP_MODE field is set to ‘1’. The RSC_Nx_{—}1 field is used for setting a paging slot observation number N_{preferredSCI-1} for the F-PCH or the F-CCCH when the SCI is equal to a preferred SCI, and its field value is set to an 80 ms-based value. If the base station requests the RSC mode operation through an ERM message, the mobile station can transmit an ERRM message as a response thereto, and this message also includes the same fields as those of the RO message.

Second Case 5-2(2): Base Station Requests RSC Mode Operation while Releasing Traffic Channel in Accordance with the Fifth Embodiment of the Present Invention

A base station transmits an ERM message to a mobile station in order to request an RSC mode operation while releasing a traffic channel. The ERM message includes the fields as shown by way of example in Table 18 below.

TABLE 18

| | |
|---|---|
| RSC_MODE_SUPPORTED | 1 |
| REQ_RSCI_INCL | 0 or 1 |
| REQ_RSCI | 0 or 4 |
| RESPOND_IND | 0 or 1 |
| RSC_OP_MODE | 0 or 1 |
| MAX_RSC_END_TIME_UNIT | 0 or 2 |
| MAX_RSC_END_TIME_VALUE | 0 or 4 |
| MAX_RSC_Nx_1 | 0 or 12 |

In Table 18, if the RSC_MODE_SUPPORTED field is set to ‘1’, it indicates that the base station supports the RSC mode for the mobile station. However, if the RSC_MODE_SUPPORTED field is set to ‘0’, it indicates that the base station does not support the RSC mode.

The REQ_RSCI_INCL field is added when the RSC_MODE_SUPPORTED field is set to ‘1’, and is omitted when the RSC_MODE_SUPPORTED field is set to ‘0’. If the base station requests the mobile station for the RSC mode operation, it sets this field to ‘1’ and includes the REQ_RSCI field in the ERM message. The REQ_RSCI_INCL field is set to ‘0’ when the base station uses the ERM message as a response to the RO message transmitted by the mobile station.

The REQ_RSCI field is included in the message when the REQ_RSCI_INCL field is set to ‘1’, and its field value is set according to Table 1. However, the REQ_RSCI field is omitted when the REQ_RSCI_INCL field is set to ‘0’.

The RESPOND_IND field is omitted when the REQ_RSCI_INCL field is set to ‘1’. Otherwise, the RESPOND_IND field is added to the message, and its value is set in the following manner. If the ERM message is transmitted as a response to a request for the RSC mode operation through the RO message from the mobile station, this field is set to ‘1’. Otherwise, this field is set to ‘0’.

The RSC_OP_MODE field is added when the REQ_RSCI_INCL field is set to ‘1’ or when the RESPOND_IND field is added and its field value is set to ‘1’. Otherwise, the RSC_OP_MODE field is omitted. If this field is set to ‘0’, it indicates that the base station requests the conventional RSC mode. However, if this field is set to ‘1’, it indicates that the base station requests the mobile station for the new RSC mode proposed in accordance with the fifth embodiment of the present invention.

The MAX_RSC_END_TIME_UNIT field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END TIME_UNIT field is omitted. A value of this field is set according to Table 5.

The MAX_RSC_END_TIME_VALUE field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_VALUE field is omitted. The base station writes a system time at which the mobile station will terminate the RSC mode operation, in this field per RSC_END_TIME_UNIT, after a modulo-16 operation.

A MAX_RSC_Nx_{—}1 field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘1’. Otherwise, the MAX_RSC_Nx_{—}1 field is omitted. The MAX_RSC_Nx_{—}1 field is used for setting a maximum value of a paging slot observation number N_{preferredSCI-1} for the F-PCH or the F-CCCH for a one-SCI operation time when the SCI is equal to a preferred SCI, and its field value is set to an 80 ms-based value.

Third Case 5-2(3): Mobile Station Requests RSC Mode Operation in Idle State in Accordance with the Fifth Embodiment of the Present Invention

A mobile station can transmit an FCSO message as shown by way of example in Table 19 below, in order to request a base station for the RSC mode operation in the idle state.

TABLE 19

| | |
|---|---|
| ORDQ | 8 |
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_Nx_1 | 0 or 12 |

Most of the fields in Table 19 are equal to the fields of the RO message except for the following ORDQ field, and a description thereof will be provided below.

If the ORDQ field is set to ‘00000000’, it indicates that the mobile station requests the base station for the RSC mode operation. If the ORDQ field is set to ‘00000001’, it indicates that the mobile station responds to the FCSO message transmitted by the base station.

Fourth Case 5-2(4): Base Station Requests RSC Mode Operation in Idle State in Accordance with the Fifth Embodiment of the Present Invention

A base station can transmit an FCSO message as shown by way of example in Table 20 below, in order to request a mobile station for the RSC mode operation in the idle state. Most of the fields are equal to the fields of the ERM message, and only the different fields will be described herein below.

TABLE 20

| | |
|---|---|
| ORDQ | 8 |
| RSC_MODE_SUPPORTED | 1 |
| RSC_OP_MODE | 0 or 1 |
| REQ_RSCI | 0 or 4 |
| MAX_RSC_END_TIME_UNIT | 0 or 2 |
| MAX_RSC_END_TIME_VALUE | 0 or 4 |
| MAX_RSC_Nx_1 | 0 or 12 |

In Table 20, if the ORDQ field is set to ‘00000000’, it indicates that the base station requests the mobile station for the RSC mode operation. If the ORDQ field is set to ‘00000001’, it indicates that the base station responds to the FCSO message transmitted by the mobile station.

The base station sets the RSC_OP_MODE field to ‘0’ to request the conventional RSC mode, and sets the RSC_OP_MODE field to ‘1’ to request the new RSC mode proposed in accordance with the fifth embodiment of the present invention.

The REQ_RSCI field is included only when the ORDQ field is set to ‘00000000’ and the RSC_MODE_SUPPORTED field is set to ‘1’. Otherwise, the REQ_RSCI field is omitted. This field is used for setting an SCI value for requesting the mobile station to operate in the RSC mode.

The MAX_RSC_END_TIME_UNIT field is added when the ORDQ field is set to ‘00000000’ or when the ORDQ field is set to ‘00000001’ and the RSC_OP_MODE field is set to ‘0’. Otherwise, the MAX_RSC_END_TIME_UNIT field is omitted. A value of this field is set according to Table 5.

The MAX_RSC_END_TIME_VALUE field is added when the ORDQ field is set to ‘00000000’ or when the ORDQ field is set to ‘00000001’ and a value of the RSC_OP_MODE field is set to ‘0’. Otherwise, the MAX_RSC_END_TIME_VALUE field is omitted. The base station writes a system time at which the mobile station will terminate the RSC mode operation, in this field per RSC_END_TIME_UNIT, after a modulo-16 operation.

The MAX_RSC_Nx_{—}1 field is added when the ORDQ field is set to ‘00000000’ or when the ORDQ field is set to ‘00000001’ and a value of the RSC_OP_MODE field is set to ‘1’. Otherwise, the MAX_RSC_Nx_{—}1 field is omitted. The MAX_RSC_Nx_{—}1 field is used for setting a maximum value of the paging slot observation number N_{preferredSCI-1} for the F-PCH or the F-CCCH when the SCI is equal to a preferred SCI, and its field value is set to an 80 ms-based value.

However, in the fifth embodiment of the present invention, when the base station transmits an FCSO message as a response to the FCSO message transmitted by the mobile station, the base station can include in the FCSO message only one field group corresponding to the RSC mode requested by the mobile station among the field groups of (MAX_RSC_END_TIME_UNIT, MAX_RSC_END_TIME_VALUE) and (MAX_RSC_Nx_{—}1). The remaining fields herein are equal to their corresponding fields of the ERM message, described above.

Case 5-3: Total Operation Time T of RSC Mode or Per-SCI Operation Time is Used as a Parameter in Accordance with the Fifth Embodiment of the Present Invention

In this case, the per-SCI operation time t is determined in accordance with Equation (3), and the message transmission method is equal to that of the first embodiment of the present invention. The case where the value t is transmitted as a parameter is equal to the corresponding case of the third embodiment of the present invention.

### Sixth Exemplary Embodiment of the Present Invention

The sixth embodiment of the present invention proposes a method in which the per-SCI operation time t is equal for each SCI and the SCI value increases step by step every time t in such a manner that only the predetermined number of SCI values increase for the per-SCI operation period. To this end, the per-SCI operation time t is determined depending on the total operation time T of the RSC mode and the number n of steps in accordance with Equation (10) below. Herein, the T value and the n value can be determined by the base station or the mobile station. The number n of steps is determined depending on the number of different SCIs used for an operation period of the RSC mode.

$$t = \frac{T}{n} \qquad ( 10 )$$

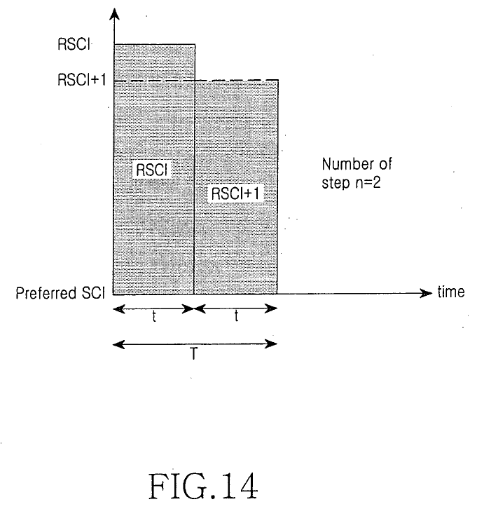

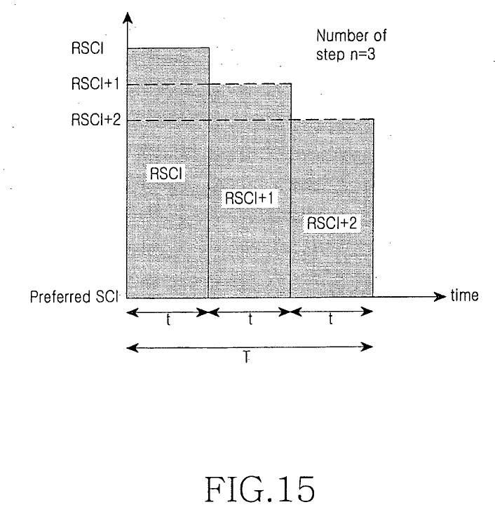

FIG. 14 is a diagram illustrating an RSC mode control method using the number of steps according to one aspect of embodiments of the present invention. In an exemplary case of FIG. 14, an initial SCI is an RSCI, and the number steps is n=2. In FIG. 14, the initial SCI is the RSCI, and after the RSC mode operates for a time t, the SCI increases by one step and the RSC mode operates with a RSCI+1 value for the time t. After a lapse of the total RSC operation time T (=2*t), the SCI value changes to the general preferred SCI value previously known to both the mobile station and the base station, terminating the RSC mode operation. FIG. 15 shows an exemplary case for the case where the number of steps is n=3.

In order to operate in the method proposed by this embodiment, the mobile station and the base station should preferably exchange the following several parameters with each other. In a first parameter exchange method, the mobile station and the base station exchange two of the parameters of RSCI (i.e. initial SCI value of {RSCI,T,n}, {RSCI,n,t} or {RSCI,T,t}), T, n, and t.

A second parameter exchange method exchanges an equivalent SCI value. The equivalent RSCI value is defined as r as shown in Equation (11), and is determined depending on the RSCI value and the n value. In Equation (11), log₂( ) denotes a long function with a base of 2.

$$γ = {log}_{2} ( \frac{n \cdot {2}^{RSCI + n - 1}}{{2}^{n} - 1} ) \qquad ( 11 )$$

Upon receipt of the value r, the mobile station or the base station can calculate the value n and the value RSCI using Equation (11). Therefore, the mobile station and the base station can negotiate the RSC mode operation by exchanging the two parameters {r, T}.

A detailed description of a format of each message will now be made separately for the following four Cases 6-1 to 6-4 according to a state of the mobile station and the subject of requesting the RSC mode operation.

First Case 6-1: Mobile Station Requests RSC Mode Operation while Releasing Traffic Channel in Accordance with the Sixth Embodiment of the Present Invention

Table 21 below shows by way of example a partial format of an RO message that a mobile station transmits while releasing a traffic channel. In this case, the types of the parameters exchanged between the mobile station and the base station are {RSCI,T,n}. A detailed description of the fields in Table 21, used in the preceding embodiments, will be omitted for simplicity.

TABLE 21

| | | Field inclusion rule (INCL: included, -: | | |
|---|---|---|---|---|
| | | not included, | | |
| | | number: field value) | | |
| | | Usage | | |
| Message body | | RSC mode | Existing RSC | Proposed RSC |
| | Number | operation not | mode operation | mode operation |
| Field name | of Bits | requested | requested | requested |
| RSC_MODE_IND | 1 | 0 | 1 | 1 |
| RSCI | 0 or 4 | — | INCL | INCL |
| RSC_END_TIME_UNIT | 0 or 2 | — | INCL | INCL |
| RSC_END_TIME_VALUE | 0 or 4 | — | INCL | INCL |
| RSC_OP_MODE | 0 or 1 | — | 0 | 1 |
| RSC_NUM_STEP | 0 or 3 | — | — | INCL |

In Table 21, if a 1-bit RSC_MODE_IND field is set to ‘1’, it indicates that the mobile station sends a request to the base station for the RSC mode operation. If the RSC_MODE_IND field is set to ‘0’, it indicates that the mobile station does not request the RSC mode operation. An RSCI field is added if the RSC_MODE_IND field is set to ‘1’, and the RSCI field is omitted if the RSC_MODE_IND field is set to ‘0’. This field is filled with an SCI value desired by the mobile station, and this field value is determined with reference to Table 1.

An RSC_END_TIME_UNIT field and an RSC_END_TIME_VALUE field used for determining an RSC mode operation time T are added if the RSC_MODE_IND field is set to ‘1’. The RSC_END_TIME_UNIT field and the RSC_END_TIME_VALUE field are omitted if the RSC_MODE_IND field is set to ‘0’. The RSC_END_TIME_UNIT field is set according to Table 5, and the mobile station writes a system time at which it will terminate the RSC mode operation, in the RSC_END_TIME_VALUE field per RSC_END_TIME_UNIT, after a modulo-16 operation. With the use of the RSC_END_TIME_UNIT field and the RSC_END_TIME_VALUE field, the RSC mode operation time T of the mobile station can be represented. That is, the RSC mode operation time T is defined as a difference between the time indicated by the RSC_END_TIME_UNIT and RSC_END_TIME_VALUE fields and the RSC mode start time.

An RSC_OP_MODE field is added if the RSC_MODE_IND field is set to ‘1’. If the RSC_MODE_IND field is set to ‘0’, the RSC_OP_MODE field is omitted. If this field is set to ‘0’, the mobile station requests the conventional RSC mode operation. If the RSC_OP_MODE field is set to ‘1’, the mobile station requests the RSC mode operation proposed in this embodiment. An RSC_NUM_STEP field is added if the RSC_MODE_IND field is set to ‘1’ and the RSC_OP_MODE field is set to ‘1’.

The RSC_NUM_STEP field indicates the number of SCI steps required during the RSC mode, and is used to indicate the number n of steps. Therefore, the SCI changes by the RSC_NUM_STEP until it returns to the preferred SCI value after termination of the RSC mode operation. The RSC mode operates with the RSCI value in its initial stage, and increases the SCI value by 1 after expiration of the corresponding SCI operation period. However, if the RSC mode operation is terminated, the SCI value changes from the RSCI+RSC_NUM_STEP-1 value to the preferred SCI value. The change in the SCI value can be greater than or equal to 1.

If the parameters exchanged between the mobile station and the base station are {RSCI,T,t} rather than {RSCI,T,n}, a 6-bit RSC_ONE_SCI_TIME field can be used in Table 21 as the field indicating the value t of Table 10, instead of the RSC_NUM_STEP field. The condition on which the RSC_ONE_SCI_TIME field is included in the message is equal to the condition on which the RSC_NUM_STEP field is included in the message.

If the parameters exchanged between the mobile station and the base station are {r, T}, an RO message shown by way of example in Table 22 below can be used.

TABLE 22

| | | Field inclusion rule (INCL: included, -: | | |
|---|---|---|---|---|
| | | not included, | | |
| | | number: field value) | | |
| | | Usage | | |
| Message body | | RSC mode | Existing RSC | Proposed RSC |
| | Number of | operation | mode operation | mode operation |
| Field name | Bits | requested | requested | requested |
| RSC_MODE_IND | 1 | 0 | 1 | 1 |
| RSC_OP_MODE | 0 or 1 | — | 0 | 1 |
| RSCI | 0 or 4 | — | INCL | — |
| RSC_END_TIME_UNIT | 0 or 2 | — | INCL | INCL |
| RSC_END_TIME_VALUE | 0 or 4 | — | INCL | INCL |
| RSC_RSCI_INT | 0 or 4 | — | — | INCL |
| RSC_RSCI_DEC | 0 or 7 | — | — | INCL |

In Table 22, if a 1-bit RSC_MODE_IND field is set to ‘1’, it indicates that the mobile station sends a request to the base station for the RSC mode operation. If the RSC_MODE_IND field is set to ‘0’, it indicates that the mobile station does not request the RSC mode operation.

An RSC_OP_MODE field is added if the RSC_MODE_IND field is set to ‘1’. Otherwise, the RSC_OP_MODE field is omitted. If this field is set to ‘0’, the mobile station requests the conventional RSC mode operation, and if this field is set to ‘1’, the mobile station requests the RSC mode operation proposed in this embodiment.

An RSCI field is added if the RSC_MODE_IND field is set to ‘1’ and the RSC_OP_MODE field is set to ‘0’. Otherwise, the RSCI field is omitted. This field is filled with the SCI value desired by the mobile station, and this field value is determined with reference to Table 1.

An RSC_END_TIME_UNIT field and an RSC_END_TIME_VALUE field used for determining an RSC mode operation time T are added if the RSC_MODE_IND field is set to ‘1’. The RSC_END_TIME_UNIT field and the RSC_END_TIME_VALUE field are omitted if the RSC_MODE_IND field is set to ‘0’. The RSC_END_TIME_UNIT field is set according to Table 5, and the mobile station writes a system time at which it will terminate the RSC mode operation, in the RSC_END_TIME_VALUE field per RSC_END_TIME_UNIT, after a modulo-16 operation. The RSC mode operation time T is defined as a difference between the time indicated by the RSC_END_TIME_UNIT and RSC_END_TIME_VALUE fields and the RSC mode start time.

The RSC_RSCI_INT and RSC_RSCI_DEC fields are added if the RSC_MODE_IND field is set to ‘1’ and the RSC_OP_MODE field is set to ‘1’. Otherwise, the RSC_RSCI_INT and RSC_RSCI_DEC fields are omitted. The RSC_RSCI_INT field indicates an integer part of the value r indicating an equivalent SCI. The RSC_RSCI_DEC field, a field indicating a decimal point of the value r, indicates a k^{th} bit value from the MSB, and a value indicated by the RSC_RSCI_DEC field is the sum of all numbers corresponding to respective bits (for k=1, 2, . . . , 8). This field, a field indicating the decimal point, can express a decimal in another method. By summing up two decimal numbers expressed by the RSC_RSCI_INT field and the RSC_RSCI_DEC field, an equivalent SCI value r can be obtained.

Second Case 6-2: Base Station Requests RSC Mode Operation while Releasing Traffic Channel in Accordance with the Sixth Embodiment of the Present Invention

A base station transmits an ERM message to a mobile station in order to request an RSC mode operation while releasing a traffic channel. Table 23 below shows by way of example the message format in the case where the types of the parameters exchanged between the mobile station and the base station are {RSCI,T,n}.

TABLE 23

| | | Field inclusion rule (INCL: included, | | | |
|---|---|---|---|---|---|
| | | —: not included, number: field value) | | | |
| | | Usage | | | |
| | | | | Proposed | |
| Message body | | Advertising | Existing | RSC mode | |
| | Number | or response | RSC mode | operation | Not |
| Field name | of Bits | to RO | operation | requested | supported |
| RSC_MODE_SUPPORTED | 1 | 1 | 1 | 1 | 0 |
| REQ_RSCI_INCL | 0 or 1 | 0 | 1 | 1 | — |
| REQ_RSCI | 0 or 4 | — | INCL | INCL | — |
| RSC_OP_MODE | 0 or 1 | — | 0 | 1 | — |
| MAX_RSC_END_TIME_UNIT | 0 or 2 | INCL | INCL | INCL | — |
| MAX_RSC_END_TIME_VALUE | 0 or 4 | INCL | INCL | INCL | — |
| RSC_NUM_STEP | 0 or 3 | — | — | INCL | — |

In Table 23, if an RSC_MODE_SUPPORTED field is set to ‘1’, it indicates that the base station supports the RSC mode for the mobile station. If the RSC_MODE_SUPPORTED field is set to ‘1’, it indicates that the base station does not support the RSC mode. An REQ_RSCI_INCL field is added when the RSC_MODE_SUPPORTED field is set to ‘1’, and is omitted when the RSC_MODE_SUPPORTED field is set to ‘0’. If the base station sends a request to the mobile station for the RSC mode operation, it sets this field to ‘1’ and includes the REQ_RSCI field in the ERM message. The REQ_RSCI_INCL field is set to ‘0’ when the base station uses the ERM message as a response to the RO message transmitted by the mobile station. The REQ_RSCI field is included when an RSQ_RSCI_INCL field is set to ‘1’, and a proposed RSCI value is set in this field.

An RSC_OP_MODE field is added when the RSC_MODE_SUPPORTED field is set to ‘1’ and the REQ_RSCI_INCL field is set to ‘1’. Otherwise, the RSC_OP_MODE field is omitted. If this field is set to ‘0’, it indicates that the mobile station requests the conventional RSC mode operation. However, if this field is set to ‘1’, it indicates that the mobile station requests the RSC mode operation proposed by this embodiment.

A MAX_RSC_END_TIME_UNIT field is added when the RSC_MODE_SUPPORTED field is set to ‘1’. Otherwise, the MAX_RSC_END_TIME_UNIT field is omitted. A value of this field is set according to Table 5. A MAX_RSC_END_TIME_VALUE field is added when the RSC_MODE_SUPPORTED field is set to ‘1’, and is omitted when the RSC_MODE_SUPPORTED field is set to ‘0’. The base station writes a maximum value of the system time when the mobile station will terminate the RSC mode operation, in the MAX_RSC_END_TIME_VALUE field per RSC_END_TIME_UNIT, and the system time value undergoes a modulo-16 operation.

An RSC_NUM_STEP field is added when the RSC_MODE_SUPPORTED field is set to ‘1’, the REQ_RSCI_INCL field is set to ‘1’, and the RSC_OP_MODE field is set to ‘1’. Otherwise, the RSC_NUM_STEP field is omitted. The RSC_NUM_STEP field indicates the number of SCI steps required during the RSC mode. The SCI changes by the RSC_NUM_STEP until it returns to the preferred SCI value after termination of the RSC mode operation. The RSC mode operates with the RSCI value in its initial stage, and increases the SCI value by 1 after expiration of the corresponding SCI operation period. However, if the RSC mode operation is terminated, the SCI value changes from the RSCI+n−1 value to the preferred SCI value. The change in the SCI value can be greater than or equal to 1.

If the parameters exchanged between the mobile station and the base station are {RSCI,T,t} rather than {RSCI,T,n}, a 6-bit RSC_ONE_SCI_TIME field indicating the value t can be used in Table 23 instead of the RSC_NUM_STEP field. The condition on which the RSC_ONE_SCI_TIME field is included in the message is equal to the condition on which the RSC_NUM_STEP field is included in the message.

If the parameters exchanged between the mobile station and the base station are {r, T}, an ERM message shown by way of example in Table 24 below can be used.

TABLE 24

| | | Field inclusion rule (INCL: included, | | | |
|---|---|---|---|---|---|
| | | —: not included, number: field value) | | | |
| | | Usage | | | |
| | | | Existing | Proposed | |
| Message body | | | RSC mode | RSC mode | |
| | Number | | operation | operation | Not |
| Field name | of Bits | Advertising | requested | requested | supported |
| RSC_MODE_SUPPORTED | 1 | 1 | 1 | 1 | 0 |
| REQ_RSCI_INCL | 0 or 1 | 0 | 1 | 1 | — |
| REQ_RSCI | 0 or 4 | — | INCL | INCL | — |
| RSC_OP_MODE | 0 or 1 | — | 0 | 1 | — |
| MAX_RSC_END_TIME_UNIT | 0 or 2 | INCL | INCL | INCL | — |
| MAX_RSC_END_TIME_VALUE | 0 or 4 | INCL | INCL | INCL | — |
| RSC_RSC I_INT | 0 or 4 | — | — | INCL | — |
| RSC_RSC I_DEC | 0 or 7 | — | — | INCL | — |

In Table 24, if an RSC_MODE_SUPPORTED field is set to ‘1’, it indicates that the base station supports the RSC mode for the mobile station. If the RSC_MODE_SUPPORTED field is set to ‘0’, it indicates that the base station does not support the RSC mode.

A REQ_RSCI_INCL field is added if the RSC_MODE_SUPPORTED field is set to ‘1’. Otherwise, the REQ_RSCI_INCL field is omitted. If the base station sends a request to the mobile station for the RSC mode operation, it sets this field to ‘1’ and the ERM message includes an RSC_MODE_IND field. If the base station uses the ERM message as a response to the RO message transmitted by the mobile station, the REQ_RSCI_INCL field is set to ‘0’.

A REQ_RSCI field is added when the RSQ_RSCI_INCL field is set to ‘1’, and a proposed RSCI value is set in this field.

A RSC_OP_MODE field is added when the RSC_MODE_SUPPORTED field is set to ‘1’ and the REQ_RSCI_INCL field is set to ‘1’. Otherwise, the RSC_OP_MODE field is omitted. If this field is set to ‘0’, the mobile station requests the conventional RSC mode operation. If this field is set to ‘1’, the mobile station requests the RSC mode operation proposed in this embodiment.

The REQ_RSCI field is included when the RSC_OP_MODE field is included, and a proposed RSCI value is included in this field.

A MAX_RSC_END_TIME_UNIT field is added when the RSC_MODE_SUPPORTED field is set to ‘1’. Otherwise, the MAX_RSC_END_TIME_UNIT field is omitted. A value of this field is set according to Table 5. A MAX_RSC_END_TIME_VALUE field is added when the RSC_MODE_SUPPORTED field is set to ‘1’. Otherwise, the MAX_RSC_END_TIME_VALUE field is omitted. The base station writes the maximum value of the system time when the mobile station will terminate the RSC mode operation, in this field per RSC_END_TIME_UNIT, and the system time value undergoes a modulo-16 operation.

An RSC_RSCI_INT field and an RSC_RSCI_DEC field are added when the RSC_MODE_IND field is set to ‘1’ and the RSC_OP_MODE field is set to ‘1’. Otherwise the RSC_RSCI_INT and RSC_RSCI_DEC fields are omitted. The RSC_RSCI_INT field indicates an integer part of the r indicating an equivalent SCI. The RSC_RSCI_DEC field, a field indicating a decimal point part, indicates a k h bit value from the MSB, and a value indicated by the RSC_RSCI_DEC field is the sum of all numbers corresponding to respective bits (for k=1, 2, . . . , 8). This field, a field indicating the decimal point, can express a decimal in another method. By summing up two decimal numbers expressed by the RSC_RSCI_INT field and the RSC_RSCI_DEC field, an equivalent SCI value r can be obtained.

Third Case 6-3: Mobile Station Requests RSC Mode Operation in Idle State in Accordance with the Sixth Embodiment of the Present Invention

To request a base station for an RSC mode operation in the idle state, a mobile station can transmit an FCSO message shown by way of example in Table 25 below to the base station. In Table 25, {RSCI,T, n} are used as the parameters for RSC mode negotiation between the mobile station and the base station. The other fields, except for an ORDQ field, have been described in connection to Table 21, so a description thereof will be omitted.

TABLE 25

| Field name | Number of Bits |
|---|---|
| ORDQ | 8 |
| RSC_MODE_IND | 1 |
| RSCI | 0 or 4 |
| RSC_END_TIME_UNIT | 0 or 2 |
| RSC_END_TIME_VALUE | 0 or 4 |
| RSC_OP_MODE | 0 or 1 |
| RSC_NUM_STEP | 0 or 3 |

If a value of the ORDQ field is set to ‘00000000’, it indicates that the mobile station requests the base station for the RSC mode operation. If a value of the ORDQ field is set to ‘00000001’, it indicates that the mobile station responds to the FCSO message transmitted by the base station.

If the parameters exchanged between the mobile station and the base station are {RSCI,T,t} rather than {RSCI,T,n}, a 6-bit RSC_ONE_SCI_TIME field indicating the value t of Equation (10) can be used in Table 25 instead of the RSC_NUM_STEP field. The condition on which the RSC_ONE_SCI_TIME field is included in the message is equal to the condition on which the RSC_NUM_STEP field is included in the message.

If the parameters exchanged between the mobile station and the base station are {r, T}, an FCSO message shown by way of example in Table 26 below can be used. Also, in this case, the other fields except for an ORDQ field have been described in connection to Table 22, so a description thereof will be omitted.

TABLE 26

| Field name | Number of Bits |
|---|---|
| ORDQ | 8 |
| RSC_MODE_IND | 1 |
| RSC_OP_MODE | 0 or 1 |
| RSCI | 0 or 4 |
| RSC_END_TIME_UNIT | 0 or 2 |
| RSC_END_TIME_VALUE | 0 or 4 |
| RSC_RSCI_INT | 0 or 4 |
| RSC_RSCI_DEC | 0 or 7 |

If a value of the ORDQ field is set to ‘00000000’, it indicates that the mobile station requests the base station for the RSC mode operation. If the value of the ORDQ field is set to ‘00000001’, it indicates that the mobile station responds to the FCSO message transmitted by the base station.

Fourth Case 6-4: Base Station Requests RSC Mode Operation in Idle State in Accordance with the Sixth Embodiment of the Present Invention

A base station can transmit an FCSO message as shown by way of example in Table 27 below, in order to request a mobile station for the RSC mode operation in the idle state. Table 27 shows an FSCO message available when {RSCI,T,n} are used as the parameters exchanged between the mobile station and the base station.

TABLE 27

| | | Field inclusion rule (INCL: included, | | | | |
|---|---|---|---|---|---|---|
| | | —: not included, number: field value) | | | | |
| | | Usage | | | | |
| | | | | | Response to | Response to |
| | | | | | RSC mode | RSC mode |
| | | | Existing | Proposed | operation | operation |
| Message body | | | RSC mode | RSC mode | request of | request of |
| | Number | Other | operation | operation | mobile | mobile |
| Field name | of Bits | usage | requested | requested | station | station |
| ORDQ | 8 | 00000000 | 00000000 | 00000000 | 00000001 | 00000001 |
| RSC_MODE_SUPPORTED | 1 | 0 | 1 | 1 | 1 | 0 |
| RSC_OP_MODE | 0 or 1 | — | 0 | 1 | — | — |
| REQ_RSCI | 0 or 4 | — | INCL | INCL | — | — |
| RSC_END_TIME_UNIT | 0 or 2 | — | INCL | INCL | INCL | — |
| RSC_END_TIME_VALUE | 0 or 4 | — | INCL | INCL | INCL | — |
| RSC_NUM_STEP | 0 or 3 | — | — | INCL | — | — |

If a value of the ORDQ field is set to ‘00000000’, it indicates that the base station sends a request to the mobile station for the RSC mode operation. If the value of the ORDQ field is set to ‘00000001’, it indicates that the base station responds to the FCSO message transmitted by the mobile station.

An RSC_OP_MODE field is included only when the ORDQ field is set to ‘00000000’ and an RSC_MODE_SUPPORTED field is set to ‘1’. Otherwise, the RSC_OP_MODE field is omitted. If this field is set to ‘0’, it indicates that the base station requests the mobile station to operate in the conventional RSC mode. If this field is set to ‘1’, it indicates that the base station requests the mobile station to operate in the RSC mode proposed in this embodiment.

A REQ_RSCI field is included when the ORDQ field is set to ‘0000000’ and the RSC_MODE_SUPPORTED field is set to ‘1’, and a requested RSCI value is set therein. A MAX_RSC_END_TIME_UNIT field can be added when the RSC_MODE_SUPPORTED field is set to ‘1’. Otherwise, the MAX_RSC_END_TIME_UNIT field is omitted. This field is set to a value of the RSC_END_TIME_UNIT field according to Table 5. A MAX_RSC_END_TIME_VALUE field is added when the RSC_MODE_SUPPORTED field is set to ‘1’. Otherwise, the MAX_RSC_END_TIME_VALUE field is omitted. The base station writes the maximum value of the system time when the mobile station will terminate the RSC mode operation, in this field per RSC_END_TIME_UNIT, and the system time value undergoes a modulo-16 operation.

A RSC_NUM_STEP field is added when the RSC_OP_MODE field is set to ‘1’. Otherwise, the RSC_NUM_STEP field is omitted. The RSC_NUM_STEP field indicates the number of SCI steps required during the RSC mode. The SCI changes by the RSC_NUM_STEP until it returns to the preferred SCI value after termination of the RSC mode operation. The RSC mode operates with the RSCI value in its initial stage, and increases the SCI value by 1 after expiration of the corresponding SCI operation period. However, if the RSC mode operation is terminated, the SCI value changes from the RSCI+n−1 value to the preferred SCI value. The change in the SCI value can be greater than or equal to 1.

If the parameters exchanged between the mobile station and the base station are {RSCI,T,t} rather than {RSCI,T,n}, an RSC_ONE_SCI_TIME field indicating the value t of Equation (1) can be used in Table 27 instead of the RSC_NUM_STEP field. The condition on which the RSC_ONE_SCI_TIME field is included in the message is equal to the condition on which the RSC_NUM_STEP field is included in the message.

If {T, r} are used as the parameters for RSC mode negotiation between the mobile station and the base station, an FSCO message shown by way of example in Table 28 below can be used.

TABLE 28

| | | Field inclusion rule (INCL: included, | | | | |
|---|---|---|---|---|---|---|
| | | —: not included, number: field value) | | | | |
| | | Usage | | | | |
| | | | | | Response to | |
| | | | | | RSC mode | Response to |
| | | | Existing | Proposed | operation | RSC mode |
| Message body | | | RSC mode | RSC mode | request of | operation |
| | Number | Other | operation | operation | mobile | request of |
| Field name | of Bits | usage | requested | requested | station | mobile station |
| ORDQ | 8 | 00000000 | 00000000 | 00000000 | 00000001 | 00000001 |
| RSC_MODE_SUPPORTED | 1 | 0 | 1 | 1 | 1 | 0 |
| RSC_OP_MODE | 0 or 1 | — | 0 | 1 | — | — |
| REQ_RSCI | 0 or 4 | — | INCL | INCL | — | — |
| RSC_END_TIME_UNIT | 0 or 2 | — | INCL | INCL | INCL | — |
| RSC_END_TIME_VALUE | 0 or 4 | — | INCL | INCL | INCL | — |
| RSC_RSCI_INT | 0 or 4 | — | — | INCL | — | — |
| RSC_RSCI_DEC | 0 or 7 | — | — | INCL | — | — |

If a value of the ORDQ field is set to ‘00000000’, it indicates that the base station sends a request to the mobile station for the RSC mode operation. If the value of the ORDQ field is set to ‘00000001’, it indicates that the base station responds to the FCSO message transmitted by the mobile station.

An RSC_OP_MODE field is included only when the ORDQ field is set to ‘00000000’ and an RSC_MODE_SUPPORTED field is set to ‘1’. Otherwise, the RSC_OP_MODE field is omitted. If this field is set to ‘0’, it indicates that the base station requests the mobile station to operate in the conventional RSC mode. If this field is set to ‘1’, it indicates that the base station requests the mobile station to operate in the RSC mode proposed in this embodiment.

A REQ_RSCI field is included only when the ORDQ field is set to ‘0000000’ and the RSC_MODE_SUPPORTED field is set to ‘1’, and a requested RSCI value is set therein. A MAX_RSC_END_TIME_UNIT field can be added when the RSC_MODE_SUPPORTED field is set to ‘1’. Otherwise, the MAX_RSC_END_TIME_UNIT field is omitted. This field is set to a value of the RSC_END_TIME_UNIT field according to Table 5. A MAX_RSC_END_TIME_VALUE field is added when the RSC_MODE_SUPPORTED field is set to ‘1’. Otherwise, the MAX_RSC_END_TIME_VALUE field is omitted. The base station writes the maximum value of the system time when the mobile station will terminate the RSC mode operation, in this field per RSC_END_TIME_UNIT, and the system time value undergoes a modulo-16 operation.

An RSC_RSCI_INT field and an RSC_RSCI_DEC field are added when the RSC_MODE_IND field is set to ‘1’ and the RSC_OP_MODE field is set to ‘1’. Otherwise, the RSC_RSCI_INT and RSC_RSCI_DEC fields are omitted. The RSC_RSCI_INT field indicates an integer part of the value r indicating an equivalent SCI. The RSC_RSCI_DEC field, a field indicating a decimal point of the value r, indicates a k^{th} bit value from the MSB, and a value indicated by the RSC_RSCI_DEC field is the sum of all numbers corresponding to respective bits (for k=1, 2, . . . , 8). This field, a field indicating the decimal point, can express a decimal in another method. By summing up two decimal numbers expressed by the RSC_RSCI_INT field and the RSC_RSCI_DEC field, an equivalent SCI value r can be obtained.

In the following description, the seventh and eighth embodiments propose exemplary methods in which the per-SCI operation time is set differently in a particular period or set differently in each individual period according to a second aspect of the present invention.

### Seventh Exemplary Embodiment of the Present Invention

The seventh embodiment of the present invention presents a method for finding each per-SCI operation time t when the number n of steps, an RSC mode operation time T, and an operation time fraction p of an initial SCI are given.

In this embodiment, the RSC mode operates during n steps, where n denotes a variable greater than or equal to 2. If n=2, the SCI increases once in the RSC mode operation period, and when the RSC mode ends, the SCI changes to the preferred SCI once more. If the number n of steps and the RSC mode operation time T are determined, each per-SCI operation time is determined through the following four conditions.

(1) The per-SCI operation time t is defined as t=T/(n−1);

(2) An operation time of the period in which the RSC mode operates with an initial SCI value (i.e. RSCI value) is defined as p*t, where p is a real number for 0≦p≦1;

(3) In the RSC mode, when an SCI value is equal to RSCI+n+1 (i.e. SCI value where the RSC mode operates before its return to the general slot period mode), an operation time of the operation period is defined as (1−p)*t; and

(4) Operation times of the remaining periods except for the first and last periods are both defined as t.

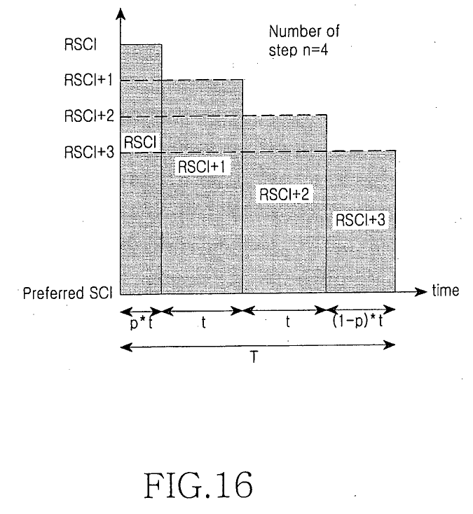

FIG. 16 is a diagram illustrating an RSC mode control method using an operation time fraction of an initial SCI according to another aspect of the present invention. In an exemplary case of FIG. 16, the number n of steps is n=4, an initial SCI value is RSCI, and the total RSC mode operation time is T. Operation times of the first and last operation periods of the RSC mode are given as p*t and (1−p)*t, respectively, and operation times of the other periods are equal to t. In the method of FIG. 16, the mobile station and the base station operate with an RSCI value, or an initial SCI, for the time p*t, and operate with RSCI+1 for a time t after the time p*t. Thereafter, the mobile station and the base station operate with an RSCI+2 value for a time t. After the SCI changes to RSCI+3, the mobile station and the base station operate with the RSCI+3 for (1−p)*t. After a lapse of the total RSC operation time T=(p*t+t+t+(1−p)*t)=3t, the mobile station and the base station end the RSC mode operation proposed in this embodiment, and start operating with the preferred SCI.

In order to operate in the method proposed by the present invention, the mobile station and the base station should preferably exchange the parameters defining the operation, and methods for performing the operation are as follows.

In a first method, the mobile station and the base station necessarily include an initial RCI value, i.e. RSCI, of the RSC mode, an operation time fraction p of the period where they operate with the first SCI, and the RSC mode operation time T, and deliver one of the parameters of the SCI, the number n of steps, and the SCI operation time t. A relationship between T, n and t is defined as T=t×(n−1). Therefore, if a transmitter delivers only one of the two parameters t and n, a receiver can find the other one. That is, the mobile station and the base station can make a parameter negotiation before starting the RSC mode operation, by delivering the parameters of {RSCI, T, n, p} or {RSCI, T, t, p}.

A second method delivers an equivalent SCI value r, and the value n. The equivalent SCI value is determined depending on the number n of steps, the fraction p of the first SCI operation period, and the initial SCI value RSCI, as shown in Equation (12). In Equation (12), log₂( ) denotes a long function with a base of 2.

$$γ = {log}_{2} ( \frac{n - 1}{1 + p} \cdot \frac{{2}^{RSCI + n - 1}}{{2}^{n - 1} - 1} ) \qquad ( 12 )$$

Upon receipt of the values r and n, the mobile station and the base station can find the values RSCI and p using Equation (12). The mobile station and the base station can make an RSC mode negotiation by delivering a 3-element parameter set {T, n, r}.

A detailed description of a format of each message will now be made separately for the following four Cases 7-1 to 7-4 according to a state of the mobile station and the subject of requesting the RSC mode operation.

First Case 7-1: Mobile Station Requests RSC Mode Operation while Releasing Traffic Channel in Accordance with the Seventh Embodiment of the Present Invention

Table 29 below shows by way of example a partial format of an RO message that a mobile station transmits while releasing a traffic channel. In this case, the types of the parameters exchanged between the mobile station and the base station are {RSCI,T,n,p}.

TABLE 29

| | | Field inclusion rule (INCL: included, -: not | | |
|---|---|---|---|---|
| | | included, number: field value) | | |
| | | Usage | | |
| | | | Existing RSC | Proposed RSC |
| Message body | | RSC mode | mode | mode |
| | Number of | operation not | operation | operation |
| Field name | Bits | requested | requested | requested |
| RSC_MODE_IND | 1 | 0 | 1 | 1 |
| RSCI | 0 or 4 | — | INCL | INCL |
| RSC_END_TIME_UNIT | 0 or 2 | — | INCL | INCL |
| RSC_END_TIME_VALUE | 0 or 4 | — | INCL | INCL |
| RSCI_OP_MODE | 0 or 1 | — | 0 | 1 |
| RSC_NUM_STEP | 0 or 3 | — | — | INCL |
| RSC_UNIT_TIME_FRACTION | 0 or 7 | — | — | INCL |

Of the fields shown in Table 29, the other fields except for a RSC_UNIT_TIME_FRACTION field have been described in connection with Table 21, so a description thereof will be omitted. Herein, only the RSC_UNIT_TIME_FRACTION field will be described.

The RSC_UNIT_TIME_FRACTION field is included when the RSC_OP_MODE field is set to ‘1’. The RSC_UNIT_TIME_FRACTION field is set to a fraction (ratio) p of the time t to an operation time of the period where the RSC mode proposed in this embodiment operates with the first SCI. If the mobile station and the base station use {RSCI,T,p,t} rather than {RSCI,T,p,n} for setting the RSC mode operation, the RSC_UNIT_TIME_FRACTION field can be replaced in Table 29 by the RSC_ONE_SCI_TIME field. The RSC_ONE_SCI_TIME field indicates the time t, and its inclusion rule in the message is equal to that of the RSC_UNIT_TIME_FRACTION field. The other fields except for the RSC_ONE_SCI_TIME field are used as defined in Table 29.

If the mobile station and the base station use the parameters {r, T, n} for setting the RSC mode operation, the fields shown by way of example in Table 30 can be used as a part of an RO message.

TABLE 30

| | | Field inclusion rule (INCL: included, -: | | |
|---|---|---|---|---|
| | | not included, | | |
| | | number: field value) | | |
| | | Usage | | |
| Message body | | RSC mode | Existing RSC | Proposed RSC |
| | Number of | operation not | mode operation | mode operation |
| Field name | Bits | requested | requested | requested |
| RSC_MODE_IND | 1 | 0 | 1 | 1 |
| RSC_OP_MODE | 0 or 1 | — | 0 | 1 |
| RSCI | 0 or 4 | — | INCL | — |
| RSC_END_TIME_UNIT | 0 or 2 | — | INCL | INCL |
| RSC_END_TIME_VALUE | 0 or 4 | — | INCL | INCL |
| RSC_RSCI_INT | 0 or 4 | — | — | INCL |
| RSC_RSCI_DEC | 0 or 7 | — | — | INCL |
| RSC_NUM_STEP | 0 or 3 | — | — | INCL |

A field inclusion rule of Table 30 is equal to that of Table 22 except for the RSC_NUM_STEP field, so a description thereof will be omitted. Herein, only the RSC_NUM_STEP field will be described. The RSC_NUM_STEP field is included when the RSC_OP_MODE field is set to ‘1’. The RSC_NUM_STEP field indicates the number of SCI steps required during the RSC mode. Generally, the SCI changes by the RSC_NUM_STEP until it returns to the preferred SCI value after the RSC mode operation ends. The RSC mode operates with the RSCI value in its initial stage, and increases the SCI value by 1 after expiration of the corresponding SCI operation period. However, if the RSC mode operation is terminated, the SCI value changes from the RSCI+n−1 value to the preferred SCI value. The change in the SCI value can be greater than or equal to 1.

Second Case 7-2: Base Station Requests RSC Mode Operation while Releasing Traffic Channel in Accordance with the Seventh Embodiment of the Present Invention

A base station transmits an ERM message to a mobile station in order to request an RSC mode operation while releasing a traffic channel. Table 31 below shows by way of example the message format in the case where the types of the parameters exchanged between the mobile station and the base station are {RSCI,T,n,p}.

TABLE 31

| | | Field inclusion rule (INCL: included, | | | |
|---|---|---|---|---|---|
| | | —: not included, number: field value) | | | |
| | | Usage | | | |
| | | | | Proposed | |
| Message body | | Advertising | Existing | RSC mode | |
| | Number | or response | RSC mode | operation | Not |
| Field name | of Bits | to RO | operation | requested | supported |
| RSC_MODE_SUPPORTED | 1 | 1 | 1 | 1 | 0 |
| REQ_RSCI_INCL | 0 or 1 | 0 | 1 | 1 | — |
| RSC_OP_MODE | 0 or 1 | — | 0 | 1 | — |
| REQ_RSCI | 0 or 4 | — | INCL | INCL | — |
| MAX_RSC_END_TIME_UNIT | 0 or 2 | INCL | INCL | INCL | — |
| MAX_RSC_END_TIME_VALUE | 0 or 4 | INCL | INCL | INCL | — |
| RSC_NUM_STEP | 0 or 3 | — | — | INCL | — |
| RSC_UNIT_TIME_FRACTION | 0 or 7 | — | — | INCL | — |

A field inclusion rule of Table 31 is equal to that of Table 23 except for the RSC_NUM_STEP field, so a description thereof will be omitted. Herein, only the RSC_UNIT_TIME_FRACTION field, a difference between FIGS. 31 and 23, will be described.

The RSC_UNIT_TIME_FRACTION field is included when the RSC_OP_MODE field is set to ‘1’. The RSC_UNIT_TIME_FRACTION field is set to a fraction p multiplied by the operation time t in the first SCI period in the RSC mode operation proposed by this embodiment.

If the mobile station and the base station use {RSCI,T,p,t} rather than {RSCI,T,p,n} for setting the RSC mode operation, the RSC_UNIT_TIME_FRACTION field can be replaced in Table 31 by the RSC_ONE_SCI_TIME field. The RSC_ONE_SCI_TIME field indicates the time t, and its inclusion rule is equal to that of the RSC_UNIT_TIME_FRACTION field. The other fields except for the RSC_ONE_SCI_TIME field are used as defined in Table 29.

If the mobile station and the base station use the parameters {r, T, n} for setting the RSC mode operation, the fields shown in Table 32 can be used as a part of an ERM message.

TABLE 32

| | | Field inclusion rule (INCL: included, | | | |
|---|---|---|---|---|---|
| | | —: not included, number: field value) | | | |
| | | Usage | | | |
| | | | Existing | Proposed | |
| Message body | | | RSC mode | RSC mode | |
| | Number | | operation | operation | Not |
| Field name | of Bits | Advertising | requested | requested | supported |
| RSC_MODE_SUPPORTED | 1 | 1 | 1 | 1 | 0 |
| REQ_RSCI_INCL | 0 or 1 | 0 | 1 | 1 | — |
| REQ_RSCI | 0 or 4 | — | INCL | INCL | — |
| RSC_OP_MODE | 0 or 1 | — | 0 | 1 | — |
| MAX_RSC_END_TIME_UNIT | 0 or 2 | INCL | INCL | INCL | — |
| MAX_RSC_END_TIME_VALUE | 0 or 4 | INCL | INCL | INCL | — |
| RSC_RSCI_INT | 0 or 4 | — | — | INCL | — |
| RSC_RSCI_DEC | 0 or 7 | — | — | INCL | — |
| RSC_NUM_STEP | 0 or 3 | — | — | INCL | — |

The field inclusion rule of Table 32 is equal to that of Table 24 except for the SRC_NUM_STEP field, so only the RSC_NUM_STEP field will be described herein. The RSC_NUM_STEP field is included when the RSC_OP_MODE field is set to ‘1’. The RSC_NUM_STEP field indicates the number of SCI steps required during the RSC mode. Generally, the SCI changes by the RSC_NUM_STEP until it returns to the preferred SCI value after the RSC mode operation ends. The RSC mode operates with the RSCI value in its initial stage, and increases the SCI value by 1 after expiration of the corresponding SCI operation period. However, if the RSC mode operation is terminated, the SCI value changes from the RSCI+n−1 value to the preferred SCI value. The change in the SCI value can be greater than or equal to 1.

Third Case 7-3: Mobile Station Requests RSC Mode Operation in Idle State in Accordance with the Seventh Embodiment of the Present Invention

To request a base station for an RSC mode operation in the idle state, a mobile station can transmit an FCSO message shown by way of example in Table 33 below to the base station. In Table 33, {RSCI,T,n,p} are used as the parameters for RSC mode negotiation between the mobile station and the base station. A field inclusion rule for the other fields except for an ORDQ field is equal to that of Table 29, so a description thereof will be omitted.

TABLE 33

| Field name | Number of Bits |
|---|---|
| ORDQ | 8 |
| RSC_MODE_IND | 1 |
| RSCI | 0 or 4 |
| RSC_END_TIME_UNIT | 0 or 2 |
| RSC_END_TIME_VALUE | 0 or 4 |
| RSC_OP_MODE | 0 or 1 |
| RSC_NUM_STEP | 0 or 3 |
| RSC_UNIT_TIME_FRACTION | 0 or 7 |

If the ORDQ field is set to ‘00000000’, it indicates that the mobile station sends a request to the base station for the RSC mode operation. If the ORDQ field is set to ‘00000001’, it indicates that the mobile station responds to the FCSO message transmitted by the base station.

If the mobile station and the base station use {RSCI,T,p,t} rather than {RSCI,T,p,n} for setting the RSC mode operation, the RSC_UNIT_TIME_FRACTION field can be replaced in Table 33 by the RSC_ONE_SCI_TIME field. The RSC_ONE_SCI_TIME field indicates the time t, and its inclusion rule is equal to that of the RSC_UNIT_TIME_FRACTION field. The other fields except for the RSC_ONE_SCI_TIME field are used as defined in Table 29.

If the parameters exchanged between the mobile station and the base station are {r, T, n}, the fields shown by way of example in Table 34 below can be used as a part of an FCSO message. In this case, the field inclusion rule for the other fields, except for the ORDQ field, is equal to that of Table 30, so a description thereof will be omitted.

TABLE 34

| Field name | Number of Bits |
|---|---|
| ORDQ | 8 |
| RSC_MODE_IND | 1 |
| RSC_OP_MODE | 0 or 1 |
| RSCI | 0 or 4 |
| RSC_END_TIME_UNIT | 0 or 2 |
| RSC_END_TIME_VALUE | 0 or 4 |
| RSC_RSCI_INT | 0 or 4 |
| RSC_RSCI_DEC | 0 or 7 |
| RSC_NUM_STEP | 0 or 3 |

If a value of the ORDQ field is set to ‘00000000’, it indicates that the mobile station sends a request to the base station for the RSC mode operation. If the value of the ORDQ field is set to ‘00000001’, it indicates that the mobile station responds to the FCSO message transmitted by the base station.

Fourth Case 7-4: Base Station Requests RSC Mode Operation in Idle State in Accordance with the Seventh Embodiment of the Present Invention

A base station can transmit an FCSO message as shown by way of example in Table 35 below, in order to send a request to a mobile station for the RSC mode operation in the idle state. This message is mostly equal to the ERM message in field setting, so only the fields that are different in the field setting will be described. Table 35 shows by way of example an FSCO message available when {RSCI,T,n,p} are used as the parameters exchanged between the mobile station and the base station.

TABLE 35

| | | Field inclusion rule (INCL: included, | | | | |
|---|---|---|---|---|---|---|
| | | —: not included, number: field value) | | | | |
| | | Usage | | | | |
| | | | | | Response | Response |
| | | | | | to RSC | to RSC |
| | | | | | mode | mode |
| | | | Existing | Proposed | operation | operation |
| Message body | | | RSC mode | RSC mode | request of | request of |
| | Number | Other | operation | operation | mobile | mobile |
| Field name | of Bits | usage | requested | requested | station | station |
| ORDQ | 8 | 00000000 | 00000000 | 00000000 | 00000001 | 00000001 |
| RSC_MODE_SUPPORTED | 1 | 0 | 1 | 1 | 1 | 0 |
| RSC_OP_MODE | 0 or 1 | — | 0 | 1 | — | — |
| REQ_RSCI | 0 or 4 | — | INCL | INCL | — | — |
| RSC_END_TIME_UNIT | 0 or 2 | — | INCL | INCL | INCL | — |
| RSC_END_TIME_VALUE | 0 or 4 | — | INCL | INCL | INCL | — |
| RSC_NUM_STEP | 0 or 3 | — | — | INCL | — | — |
| RSC_UNIT_TIME_FRACTION | 0 or 7 | — | — | INCL | — | — |

If a value of the ORDQ field is set to ‘00000000’, it indicates that the base station sends a request to the mobile station for the RSC mode operation. If the value of the ORDQ field is set to ‘00000001’, it indicates that the base station responds to the FCSO message transmitted by the mobile station. The fields of Table 35 are equal to the fields shown in Table 27 except for the RSC_UNIT_TIME_FRACTION field in terms of the field configuration rule and definition, so only the RSC_UNIT_TIME_FRACTION field will be described.

The RSC_UNIT_TIME_FRACTION field is included when the RSC_OP_MODE field is set to ‘1’. This field is set to a fraction p of the time t to an operation time of the period where the RSC mode proposed in this embodiment operates with the first SCI. If the mobile station and the base station use {RSCI,T,p,t} rather than {RSCI,T,p,n} for setting the RSC mode operation, the RSC_UNIT_TIME_FRACTION field can be replaced in Table 35 by the RSC_ONE_SCI_TIME field. The RSC_ONE_SCI_TIME field indicates the time t, and its inclusion rule is equal to that of the RSC_UNIT_TIME_FRACTION field. The other fields, except for the RSC_ONE_SCI_TIME field, are used as defined in Table 29.

If the mobile station and the base station use the parameters {T, r, n} for RSC mode negotiation, an FSCO message shown by way of example in Table 36 below can be used.

TABLE 36

| | | Field inclusion rule (INCL: included, | | | | |
|---|---|---|---|---|---|---|
| | | —: not included, number: field value) | | | | |
| | | Usage | | | | |
| | | | | | Response to | Response to |
| | | | | | RSC mode | RSC mode |
| | | | Existing | Proposed | operation | operation |
| Message body | | | RSC mode | RSC mode | request of | request of |
| | Number | Other | operation | operation | mobile | mobile |
| Field name | of Bits | usage | requested | requested | station | station |
| ORDQ | 8 | 00000000 | 00000000 | 00000000 | 00000001 | 00000001 |
| RSC_MODE_SUPPORTED | 1 | 0 | 1 | 1 | 1 | 0 |
| RSC_OP_MODE | 0 or 1 | — | 0 | 1 | — | — |
| REQ_RSCI | 0 or 4 | — | INCL | INCL | — | — |
| RSC_END_TIME_UNIT | 0 or 2 | — | INCL | INCL | INCL | — |
| RSC_END_TIME_VALUE | 0 or 4 | — | INCL | INCL | INCL | — |
| RSC_RSCI_INT | 0 or 4 | — | — | INCL | — | — |
| RSC_RSCI_DEC | 0 or 7 | — | — | INCL | — | — |
| RSC_NUM_STEP | 0 or 3 | — | — | INCL | — | — |

If a value of the ORDQ field is set to ‘00000000’, it indicates that the base station sends a request to the mobile station for the RSC mode operation. If the value of the ORDQ field is set to ‘00000001’, it indicates that the base station responds to the FCSO message transmitted by the mobile station. The fields of Table 36 are equal to the fields shown in Table 28 except for the RSC_NUM_STEP field in terms of the field inclusion rule and definition thereof, so only the RSC_NUM_STEP field will be described.

The RSC_NUM_STEP field is included when the RSC_OP_MODE field is set to ‘1’. The RSC_NUM_STEP field indicates the number of SCI steps required during the RSC mode. Generally, the SCI changes by the RSC_NUM_STEP until it returns to the preferred SCI value after the RSC mode operation ends. The RSC mode operates with the RSCI value in its initial stage, and increases the SCI value by 1 after expiration of the corresponding SCI operation period. However, if the RSC mode operation is terminated, the SCI value changes from the RSCI+n−1 value to the preferred SCI value. The change in the SCI value can be greater than or equal to 1.

### Eighth Exemplary Embodiment of the Present Invention

The eighth embodiment according another aspect of the present invention proposes a method in which a different per-SCI operation time t is used for each SCI operation period.

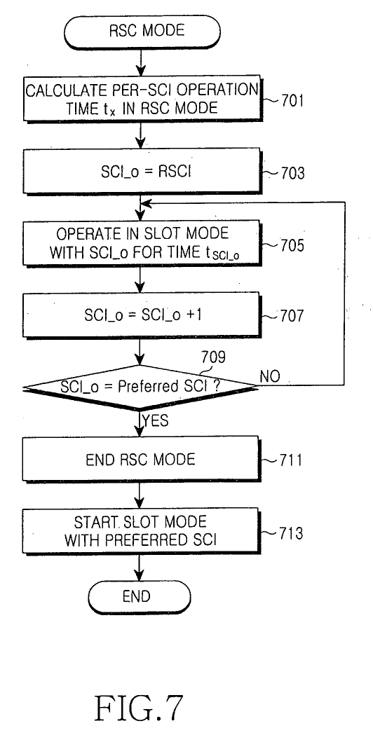

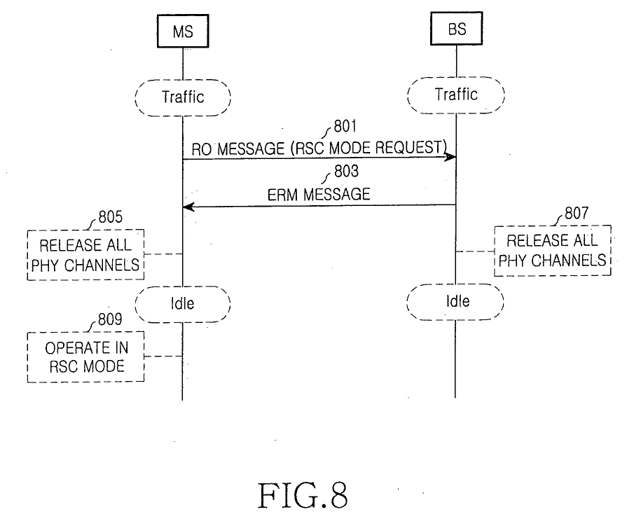

Herein, a description will be made of a basic concept of the eighth embodiment of the present invention with reference to FIG. 7. Thereafter, with reference to FIGS. 8 to 11, a description will be made of detailed embodiments of the present invention, separated according to the subject of releasing the traffic channel and the subject of requesting the RSC mode. The parameters described below are transmitted through message transmission processes between a mobile station and a base station, and the message transmission processes according to the detailed embodiments are illustrated in FIGS. 8 to 11. Before a description of the eighth embodiment of the present invention is given, its detailed embodiment variations will be described in brief below. The message transmission processes of FIGS. 8 to 11 can also be applied to the RO, ERM, ERRM message transmission processes between the mobile station and the base station in the first to seventh embodiments of the present invention.

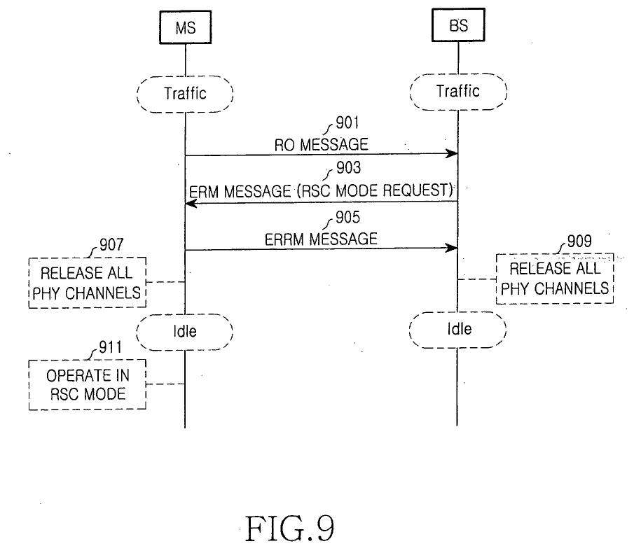

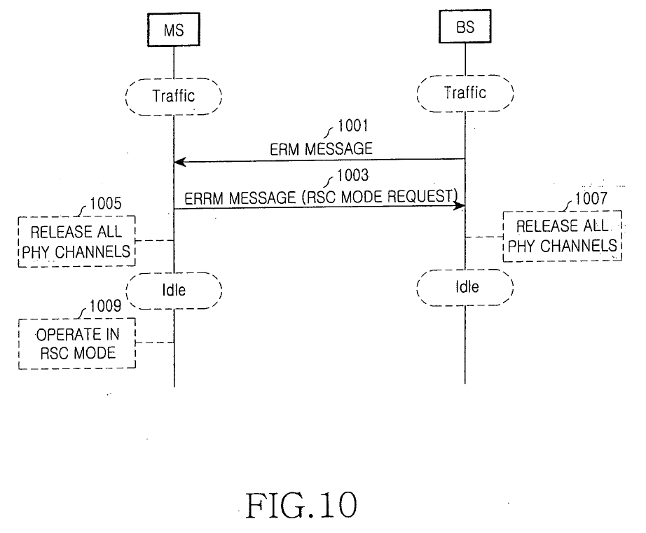

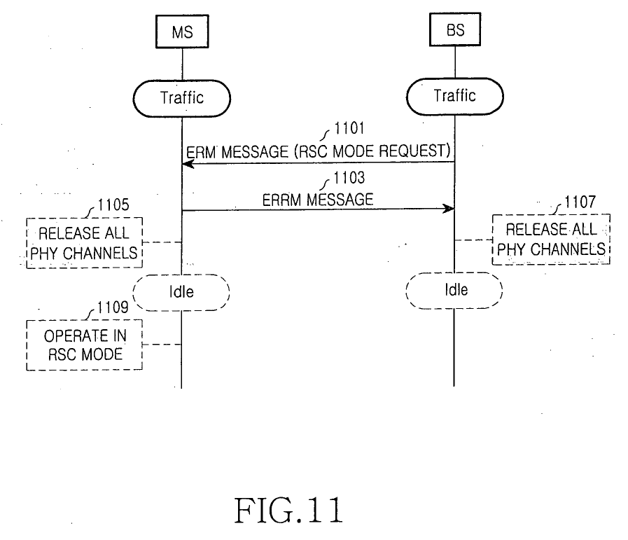

FIG. 8 is a signaling diagram illustrating a message transmission process in which a mobile station releases a traffic channel and requests an RSC mode operation through an RO message. FIG. 9 is a signaling diagram illustrating a message transmission process in which a base station requests the RSC mode operation through an ERM message even though the mobile station does not release the traffic channel and request the RSC mode operation. FIG. 10 is a signaling diagram illustrating a message transmission process in which the mobile station requests the RSC mode operation through an ERRM message even though the base station does not release the traffic channel and request the RSC mode operation. Finally, FIG. 11 is a signaling diagram illustrating a message transmission process in which the base station releases the traffic channel and requests the RSC mode operation through the ERM message, and in this case, the ERRM message transmitted by the mobile station serves as a response message.

The message transmission processes for the detailed embodiments are well shown and illustrated in FIGS. 8 to 11, and detailed descriptions thereof are provided below. Message formats for the eighth embodiment will be described in detail herein below. Although the messages used in the eighth embodiment of the present invention have been described mainly for the case where the messages are used for requesting the RSC mode operation, it should be noted that each message can be used not only for requesting the RSC mode operation, but also for responding to the request, as long as it follows the field configuration rule.

In the eighth embodiment of the present invention, if an SCI is equal to an RSCI, a paging slot observation number N_{RSCI} for the F-PCH or the F-CCCH is calculated by one of the following Equations (13) to (15) below.

$$\begin{matrix}{N}_{RSCI} = ⌈ \frac{ln 2}{α {T}_{RSCI}} ⌉ & ( 13 ) \\ {N}_{RSCI} = ⌊ \frac{ln 2}{α {T}_{RSCI}} ⌋ & ( 14 ) \\ {N}_{RSCI} = round ( \frac{ln 2}{α {T}_{RSCI}} ) & ( 15 )\end{matrix}$$

Herein, ln( ) denotes a natural logarithm function, T_{RSCI} denotes a slot cycle length in the RSC mode, └x┘ denotes a flooring operator for determining the greatest integer among the integers being less than or equal to a value x, ┌x┐ denotes a ceiling operator for determining the smallest integer among the integers being greater than or equal to a value x, round( ) denotes a round-up operator, and α denotes a parameter used for determining a distribution function of a call inter-arrival time.

In each SCI operation period based on the RSC mode, a paging slot observation number Nₓ for the F-PCH or the F-CCCH is calculated by one of the following Equations (16) to (18).

$$\begin{matrix}{N}_{x} = ⌈ \frac{{N}_{x - 1}}{2} ⌉ & ( 16 ) \\ {N}_{x} = ⌊ \frac{{N}_{x - 1}}{2} ⌋ & ( 17 ) \\ {N}_{x} = round ( \frac{{N}_{x - 1}}{2} ) & ( 18 )\end{matrix}$$

Herein, x indicating an SCI value in each SCI operation period, is determined to be in a range of RSCI≦x≦(preferred SCI-1), and Nₓ₋₁ denotes a paging slot observation number in a previous SCI operation period. A per-SCI operation time tₓ is calculated by Equation (19) below.
tₓ=Nₓ×Tₓ (19)

FIG. 7 is a flowchart for illustrating an RSC mode control method according to another aspect of embodiments of the present invention. Once the RSC mode operation starts, a mobile station calculates a different per-SCI operation timeₓ in step 701 using a paging slot observation number Nₓ for the F-PCH or the F-CCCH and a slot cycle length Tₓ in each SCI operation period determined by Equations (13) to (19). In step 703, the mobile station sets a parameter SCI_o used for storing an SCI to its initial value of RSCI. In step 705, the mobile station performs a slot mode operation with the SCI_o for the time tₓ calculated in step 701 for each SCI operation period.

In step 707, the mobile station increases the parameter SCI_o by one after a lapse of the time tₓ. In step 709, the mobile station compares the increased SCI_o with a preferred SCI. If the two values are equal to each other, the mobile station terminates the RSC mode operation in step 711. However, if the two values are different from each other, the mobile station returns to step 705 to repeat the slot mode operation with the increased SCI_o for the time tₓ. The mobile station repeats the operation of steps 705 through 709 until the SCI_o becomes equal to the preferred SCI. If the two values become equal to each other, the mobile station terminates the RSC mode operation. Thereafter, in step 713, the mobile station resumes the general slot mode operation with the preferred SCI.

In the eighth embodiment of the present invention, the mobile station or the base station transmits a value Nₓ or a value α as a parameter for calculating a value tₓ of the mobile station in the message transmission process. Therefore, a description of the detailed embodiments of the present invention will be made separately for Case 8-1 where the value Nₓ is transmitted as the parameter, and Case 8-2 where the value α is transmitted as the parameter.

Case 8-1: Paging Slot Observation Number N_{RSCI} is Used as a Parameter in Accordance with the Eighth Embodiment of the Present Invention

In this case, a per-SCI operation time tₓ is defined using Equations (16) to (19).

In Case 8-1, a detailed description of a format of each message distinguished according to the status of the mobile station and the subject of requesting the RSC mode operation will now be made separately for the following four Cases 8-1 (1) to 8-1(4).

First Case 8-1(1): Mobile Station Requests RSC Mode Operation while Releasing Traffic Channel in Accordance with the Eighth Embodiment of the Present Invention

In this case, a mobile station performs a message transmission process of FIG. 8. Table 37 shows by way of example a partial format of an RO message that the mobile station transmits while releasing a traffic channel in step 801. A detailed description of the fields in Table 37, used in the preceding embodiments, will be omitted for simplicity.

TABLE 37

| | |
|---|---|
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_N_RSCI | 0 or 13 |

In Table 37, if the 1-bit RSC_MODE_IND field for indicating whether to perform the RSC mode is set to ‘1’, it indicates that the mobile station informs the base station that it will operate in the RSC mode. If the RSC_MODE_IND field is set to ‘0’, it indicates that there is no need to operate in the RSC mode. The RSCI field is added when the RSC_MODE_IND field is set to ‘1’, and is omitted when the RSC_MODE_IND field is set to ‘0’. This field carries an SCI value desired by the mobile station, and its field value is determined with reference to Table 1.

The RSC_OP_MODE field is added when the RSC_MODE_IND field is set to ‘1’, and is omitted when the RSC_MODE_IND field is set to ‘0’. If this field is set to ‘0’, the mobile station operates in the conventional RSC mode, and if this field is set to ‘1’, the mobile station operates in the new RSC mode proposed in accordance with the eighth embodiment of the present invention. The RSC_END_TIME_UNIT field is added when the RSC_OP_MODE field is set to ‘0’, and is omitted when the RSC_OP_MODE field is set to ‘1’. A value of this field is set according to Table 5.

The RSC_END_TIME_VALUE field in Table 37 is added when the RSC_OP_MODE field is set to ‘0’, and is omitted when the RSC_OP_MODE field is set to ‘1’. The mobile station writes a system time at which it will terminate the RSC mode operation, in this field per RSC_END_TIME_UNIT, after a modulo-16 operation. An RSC_N_RSCI field is omitted when the RSC_OP_MODE field is set to ‘0’, and is included when the RSC_OP_MODE field is set to ‘1’. The RSC_N_RSCI field is used for setting a paging slot observation number N_{RSCI} for the F-PCH or the F-CCCH when the SCI is equal to a preferred SCI, and its field value is set to an 80 ms-based value.

In step 803 of the method illustrated in FIG. 8, the base station transmits an ERM message as a response message to the RO message transmitted by the mobile station. In step 805 and step 807, the mobile station and the base station release all of their physical channels. Thereafter, in step 809, the mobile station transitions to the idle state due to the release of the physical channels, and then operates in the RSC mode.

If the base station receiving the RO message in step 901 requests the RSC mode operation through an ERM message in step 903 of FIG. 9, the mobile station can transmit an ERRM message as a response thereto in step 905, and the ERRM message also includes the same fields as those of the RO message. In step 907 and step 909, the mobile station and the base station release all of their physical channels. Thereafter, in step 911, the mobile station transitions to the idle state due to the release of the physical channels, and then operates in the RSC mode.

Second Case 8-1(2): Base Station Requests RSC Mode Operation while Releasing Traffic Channel in Accordance with the Eighth Embodiment of the Present Invention

In this case, a base station performs a message transmission process of FIG. 11. In step 1101, the base station transmits an ERM message to a mobile station in order to request an RSC mode operation while releasing a traffic channel. The ERM message includes the fields as shown by way of example in Table 38 below.

TABLE 38

| | |
|---|---|
| RSC_MODE_SUPPORTED | 1 |
| REQ_RSCI_INCL | 0 or 1 |
| REQ_RSCI | 0 or 4 |
| RESPOND_IND | 0 or 1 |
| RSC_OP_MODE | 0 or 1 |
| MAX_RSC_END_TIME_UNIT | 0 or 2 |
| MAX_RSC_END_TIME_VALUE | 0 or 4 |
| RSC_N_RSCI | 0 or 13 |

In Table 38, if the RSC_MODE_SUPPORTED field is set to ‘1’, it indicates that the base station supports the RSC mode for the mobile station. However, if the RSC_MODE_SUPPORTED field is set to ‘0’, it indicates that the base station does not support the RSC mode. The REQ_RSCI_INCL field is added when the RSC_MODE_SUPPORTED field is set to ‘1’, and is omitted when the RSC_MODE_SUPPORTED field is set to ‘0’. If the base station sends a request to the mobile station for the RSC mode operation, it sets this field to ‘1’ and includes the REQ_RSCI field in the ERM message. The REQ_RSCI_INCL field is set to ‘0’ when the base station uses the ERM message as a response to the RO message transmitted by the mobile station.

The REQ_RSCI field is included in the message when the REQ_RSCI_INCL field is set to ‘1’, and in this case, an SCI value is set according to Table 1. However, the REQ_RSCI field is omitted when the REQ_RSCI_INCL field is set to ‘0’. The RESPOND_IND field is omitted when the REQ_RSCI_INCL field is set to ‘1’. Otherwise, the RESPOND_IND field is added to the message, and its value is set in the following manner. If the ERM message is transmitted as a response to a request for the RSC mode operation through the RO message from the mobile station, this field is set to ‘1’. Otherwise, this field is set to ‘0’.

The RSC_OP_MODE field is added when the REQ_RSCI_INCL field is set to ‘1’ or when the RESPOND_IND field is added and its field value is set to ‘1’. Otherwise, the RSC_OP_MODE field is omitted. If this field is set to ‘0’, it indicates that the base station requests the conventional RSC mode. However, if this field is set to ‘1’, it indicates that the base station sends a request to the mobile station for the new RSC mode proposed in accordance with the sixth embodiment of the present invention.

The MAX_RSC_END_TIME_UNIT field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_UNIT field is omitted. A value of this field is set according to Table 5.

The MAX_RSC_END_TIME_VALUE field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘0’. Otherwise, the MAX_RSC_END_TIME_VALUE field is omitted. The base station writes a system time at which the mobile station will terminate the RSC mode operation, in this field per RSC_END_TIME_UNIT, after a modulo-16 operation.

A MAX_RSC_N_RSCI field is added either (i) when the REQ_RSCI_INCL field is set to ‘0’ and the RESPOND_IND field is set to ‘0’, (ii) when the REQ_RSCI_INCL field is set to ‘1’, or (iii) when the REQ_RSCI_INCL field is set to ‘0’, the RESPOND_IND field is set to ‘1’ and the RSC_OP_MODE field is set to ‘1’. Otherwise, the MAX_RSC_N_RSCI field is omitted. The MAX_RSC_N_RSCI field is used for setting a minimum value of a paging slot observation number N_{RSCI} for the F-PCH or the F-CCCH for a one-SCI operation time when the SCI is equal to an RSCI, and its field value is set to an 80 ms-based value.

In step 1103 of FIG. 11, the mobile station transmits an ERRM message as a response message to the ERM message transmitted by the base station. In step 1105 and step 1107, the mobile station and the base station release all of their physical channels. Thereafter, in step 1109, the mobile station transitions to the idle state due to the release of the physical channels, and then operates in the RSC mode.

As shown in FIG. 10, upon receiving the ERM message in step 1001, the mobile station can request the RSC mode operation through the ERRM message in step 1003. Then, in step 1005 and step 1007, the mobile station and the base station release all of their physical channels. Thereafter, in step 1009, the mobile station transitions to the idle state due to the release of the physical channels, and then operates in the RSC mode.

Third Case 8-1(3): Mobile Station Requests RSC Mode Operation in Idle State in Accordance with the Eighth Embodiment of the Present Invention

A mobile station can transmit an FCSO message as shown by way of example in Table 39 below, in order to request a base station for the RSC mode operation in the idle state.

TABLE 39

| | |
|---|---|
| ORDQ | 8 |
| RSC_MODE_IND | 1 |
| RSCI | 0 or 4 |
| RSC_OP_MODE | 0 or 1 |
| RSC_END_TIME_UNIT | 0 or 2 |
| RSC_END_TIME_VALUE | 0 or 4 |
| RSC_N_RSCI | 0 or 13 |

Most of the fields in Table 39 are equal to the fields of the RO message except for the following ORDQ field, and a description thereof will be provided below. If the ORDQ field is set to ‘00000000’, it indicates that the mobile station sends a request to the base station for the RSC mode operation. If the ORDQ field is set to ‘00000001’, it indicates that the mobile station responds to the FCSO message transmitted by the base station.

Fourth Case 8-1(4): Base Station Requests RSC Mode Operation in Idle State in Accordance with the Eighth Embodiment of the Present Invention

A base station can transmit an FCSO message as shown by way of example in Table 40 below, in order to request a mobile station for the RSC mode operation in the idle state. Most of the fields are equal to the fields of the ERM message, and only the different fields will be described herein below.

TABLE 40

| | |
|---|---|
| ORDQ | 8 |
| RSC_MODE_SUPPORTED | 1 |
| RSC_OP_MODE | 0 or 1 |
| REQ_RSCI | 0 or 4 |
| MAX_RSC_END_TIME_UNIT | 0 or 2 |
| MAX_RSC_END_TIME_VALUE | 0 or 4 |
| MAX_RSC_N_RSCI | 0 or 13 |

In Table 40, if the ORDQ field is set to ‘00000000’, it indicates that the base station sends a request to the mobile station for the RSC mode operation. If the ORDQ field is set to ‘00000001’, it indicates that the base station responds to the FCSO message transmitted by the mobile station. The base station sets the RSC_OP_MODE field to ‘0’ to request the conventional RSC mode, and sets the RSC_OP_MODE field to ‘1’ to request the new RSC mode proposed in accordance with the eight embodiment of the present invention.

The REQ_RSCI field is included only when the ORDQ field is set to ‘00000000’ and the RSC_MODE_SUPPORTED field is set to ‘1’. Otherwise, the REQ_RSCI field is omitted. This field is used for setting an SCI value for requesting the mobile station to operate in the RSC mode. The MAX_RSC_END_TIME_UNIT field is added when the ORDQ field is set to ‘00000000’ or when the ORDQ field is set to ‘00000001’ and the RSC_OP_MODE field is set to ‘0’. Otherwise, the MAX_RSC_END_TIME_UNIT field is omitted. A value of the MAX_RSC_END_TIME_UNIT field is set according to Table 5.

The MAX_RSC_END_TIME_VALUE field is added when the ORDQ field is set to ‘00000000’ or when the ORDQ field is set to ‘00000001’ and a value of the RSC_OP_MODE field is set to ‘0’. Otherwise, the MAX_RSC_END_TIME_VALUE field is omitted. The base station writes a system time at which the mobile station will terminate the RSC mode operation, in this field per RSC_END_TIME_UNIT, after a modulo-16 operation.

The MAX_N_RSCI field is added when the ORDQ field is set to ‘00000000’ or when the ORDQ field is set to ‘00000001’ and a value of the RSC_OP_MODE field is set to ‘1’. Otherwise, the MAX_N_RSCI field is omitted. The MAX_N_RSCI field is used for setting a maximum value of the paging slot observation number N_{RSCI} for the F-PCH or the F-CCCH when the SCI is equal to an RSCI, and its field value is set to an 80 ms-based value. The remaining fields herein are equal to their corresponding fields of the ERM message, described above.

Case 8-2: α is Used as a Parameter in Accordance with the Eighth Embodiment of the Present Invention

In this case, a per-SCI operation time tₓ that can be set differently for each SCI operation period described in connection with FIG. 2, can be determined using Equation (13) to Equation (19). Further, this case is equal to that of the fourth embodiment of the present invention in terms of the message transmission method for transmitting the parameter α except for the method of determining the value tₓ, so a detailed description thereof will be omitted for simplicity.

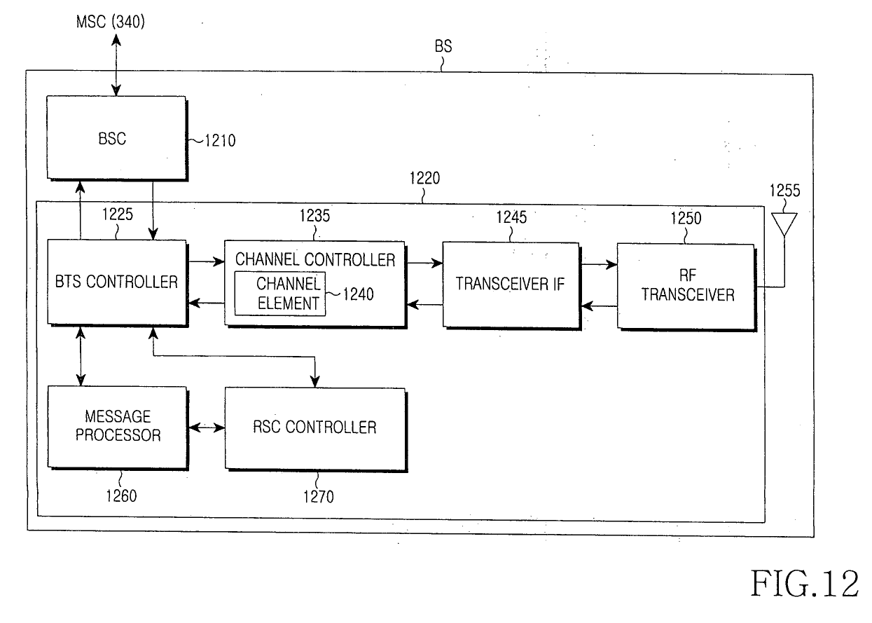

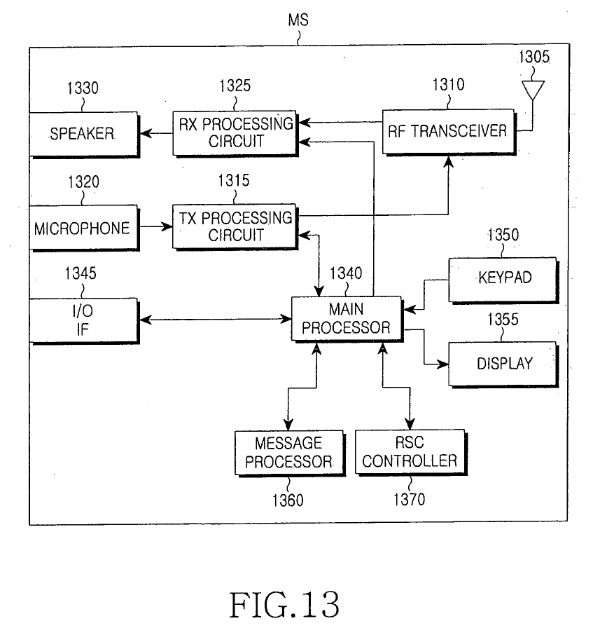

With reference to FIGS. 12 and 13, a description will now be made of exemplary structures of a base station and a mobile station according to the first to eighth embodiments of the present invention.

FIG. 12 is a block diagram illustrating a structure of a base station in a mobile communication system, to which an RSC mode control method for paging according to embodiments of the present invention is applied. This structure can be applied to the base stations 301 to 303 of FIG. 3.

Referring to FIG. 12, the base station comprises a base station controller (BSC) 1210 and a base transceiver station (BTS) 1220. The BSC 1210 manages radio resources in its cell. The BTS 1220 comprises a BTS controller 1225, a channel controller 1235, a transceiver interface (IF) 1245, a radio frequency (RF) transceiver 1250, and an antenna 1255. The BTS controller 1225 controls an operation of the channel controller 1235, and the channel controller 1235 comprises one or more channel elements 1240, such as channel cards, for performing bidirectional communication with forward channels and reverse channels. The transceiver IF 1245 exchanges channel signals with the channel controller 1235 and the RF transceiver 1250.

The antenna 1255 transmits forward channel signals received from the RF transceiver 1250 to mobile stations located in a coverage area of the base station. Further, the antenna 1255 provides the RF transceiver 1250 with reverse channel signals received from the mobile stations located in the coverage area of the base station. The BTS 1220 further comprises a message processor 1260 for transmitting/receiving various messages including parameters for control of the RSC mode, and an RSC controller 1270 for analyzing parameters received from a mobile station through the messages and setting parameters to be transmitted to the mobile station. In particular, the RSC controller 1270 comprises an RSC mode control algorithm according to embodiments of the present invention, and exchanges messages including corresponding parameters with the mobile station through a paging channel so that the mobile station can calculate a per-SCI operation time t that increases from an RSCI up to a preferred SCI step by step, or calculates the per-SCI operation time t and transmits the calculated per-SCI operation time t to the mobile station.

When the mobile station sends a request to the base station for the RSC mode operation according to the first to eighth embodiments of the present invention, the message processor 1260 receives an RO message or an FCSO message including parameters for setting a per-SCI operation time t from the mobile station, extracts the corresponding parameters from the received message, generates an ERM message or an FCSO message as a response message thereto according to a predetermined message format, and transmits the generated message. When the base station sends a request to the mobile station for the RSC mode operation according to the first to eighth embodiments of the present invention, the message processor 1260 generates an ERM or FCSO message including parameters for setting the per-SCI operation time t according to a predetermined message format, and transmits the generated message. Also, the message processor 1260 receives an ERRM message or an FCSO message from the mobile station as a response message to the transmitted message and analyzes the received message.

In addition, the RSC controller 1270 sets a paging slot position and a paging slot cycle length for each mobile station according to a per-SCI operation time t set within the total operation time T for the RSC mode. Then, the base station and the mobile station perform the RSC mode operation according to the set paging slot position and paging slot cycle length. A format of the messages and parameters included in the messages have been described above with reference to the first to eighth embodiments of the present invention, so a detailed description thereof will be omitted.

FIG. 13 is a block diagram illustrating an exemplary structure of a mobile station in a mobile communication system, to which an RSC mode control method for paging according to embodiments of the present invention is applied. This structure can be applied to the mobile stations 311 to 314 of FIG. 3.

Referring to FIG. 13, the mobile station comprises an antenna 1305, an RF transceiver 1310, a transmission processing circuit 1315, a microphone 1320, a reception processing circuit 1325, and a speaker 1330. Further, the mobile station comprises a main processor 1340, an input/output (I/O) interface (IF) 1345, a keypad 1350, and a display unit 1355. In addition, the mobile station comprises a message processor 1360 and an RSC controller 1370 for controlling an RSC mode operation according to embodiments of the present invention.

The RF transceiver 1310 receives an RF signal transmitted from the base station via the antenna 1305. The RF transceiver 1310 frequency-down-converts the received RF signal into a baseband signal. The reception processing circuit 1325 decodes the baseband signal into a voice signal or packet data. The voice signal is output to the speaker 1330, and the packet data is provided to the main processor 1340 for other processing, such as web browsing.

The transmission processing circuit 1315 receives a voice signal from the microphone 1320 or receives packet data from the main processor 1340, and encodes the received voice signal or packet data into a baseband signal. The RF transceiver 1310 frequency-up-converts the baseband signal into an RF signal, and transmits the RF signal to a wireless network via the antenna 1305. The main processor 1340 includes a basic operation system (OS) program for controlling the overall operation of the mobile station.

The main processor 1340 is connected to the I/O interface 1345 to receive parameters proposed in accordance with embodiments of the present invention from outside and initializes the parameters. The I/O interface 1345 serves to connect the mobile station to other communication devices such as a lap-top computer, portable computer, and the like. Further, the main processor 1340 is connected to the keypad 1350 and the display unit 1355 and receives key inputs from a user and displays an operating state of the mobile station.

Further, the main processor 1340 comprises the message processor 1360 for transmitting/receiving various messages including parameters for the control of the RSC mode according to embodiments of the present invention, and the RSC controller 1370 for setting parameters transmitted to the base station through the messages and analyzing parameters received from the base station. In particular, the RSC controller 1370 including an RSC mode control algorithm according to embodiments of the present invention, exchanges messages including corresponding parameters with the base station through a paging channel so that the mobile station can calculate a per-SCI operation time t that increases from an RSCI up to a preferred SCI step by step, or receives the per-SCI operation time t from the base station.

When the mobile station sends a request to the base station for the RSC mode operation according to the first to eighth embodiments of the present invention, the message processor 1360 generates an RO message or an FCSO message including parameters for setting a per-SCI operation time t according to a predetermined message format and transmits the generated message. Further, the message processor 1360 receives an ERM message or an FCSO message from the base station as a response message to the transmitted message, and analyzes the received message. However, when the base station requests the mobile station for the RSC mode operation, the message processor 1360 receives an ERM message or an FCSO message including parameters for setting the per-SCI operation time t from the base station, extracts the corresponding parameters from the received message, generates an ERRM message or an FCSO message as a response message thereto according to a predetermined message format, and transmits the generated message.

In addition, the RSC controller 1370 sets a paging slot cycle length of the mobile station according to the per-SCI operation time t set within the total operation time T for the RSC mode, increases the SCI value step by step each time the per-SCI operation time arrives, and terminates the RSC mode if the increased SCI value reaches an SCI value of the idle state, performing the RSC mode operation in accordance with embodiments of the present invention. A format of the messages and parameters included in the messages have been described above with reference to the first to eighth embodiments of the present invention, so a detailed description thereof will be omitted.

As can be understood from the foregoing description, compared with the conventional RSC mode control method, the RSC mode control method of embodiments of the present invention reduces an average delay time required when a base station transmits a message to a mobile station, providing higher RSC mode performance with less energy consumption.

In addition, when there is a frequent call connection request between the base station and the mobile station, the RSC mode control method of embodiments of the present invention can reduce an average paging delay time of the mobile station, thereby providing an efficient high-speed messaging/call service.

While the present invention has been shown and described with reference to certain exemplary embodiments thereof, it will be understood by those skilled in the art that various changes in form and details may be made therein without departing from the spirit and scope of the invention as defined by the appended claims and their equivalents.

1. A reduced slot cycle (RSC) mode control method for observing a paging slot by a mobile station to receive a message transmitted from a base station in a mobile communication system, the method comprising the steps of:
determining at least one parameter related to a total operation time of the RSC mode and a number of operation periods where the mobile station operates with different slot cycle indexes (SCIs), through an exchange of at least one message with the base station;
calculating a SCI operation time of each slot period in the RSC mode using the determined parameter; and
performing the RSC mode in the each slot period for the calculated SCI operation time.

2. The RSC mode control method of claim 1, wherein the SCI operation time of each slot period is set equally for each operation period.

3. The RSC mode control method of claim 1, wherein the SCI operation time of each slot period is set differently for at least one operation period.

4. The RSC mode control method of claim 1, wherein the step of exchanging a message comprises the steps of:
requesting, by the mobile station, the RSC mode by transmitting a release order (RO) message to the base station while releasing a traffic channel; and
transmitting, by the base station, an extended release message (ERM) to the mobile station as a response to the RO message.

5. The RSC mode control method of claim 1, wherein the step of exchanging a message comprises the steps of:
requesting, by the base station, the RSC mode by transmitting an ERM message to the mobile station while releasing a traffic channel; and
transmitting, by the mobile station, an extended release response message (ERRM) to the base station as a response to the ERM message.

6. The RSC mode control method of claim 1, wherein the step of exchanging a message comprises the steps of:
requesting, by the mobile station, the RSC mode by transmitting a fast call setup order (FCSO) message to the base station in an idle state; and
responding to the FCSO message by the base station.

7. The RSC mode control method of claim 1, wherein the step of exchanging a message comprises the steps of:
requesting, by the base station, the RSC mode by transmitting an FCSO message to the mobile station in an idle state; and
responding to the FCSO message by the mobile station.

8. The RSC mode control method of claim 1, wherein at least one of the messages exchanged with the base station comprises an RSC operation mode (RSC_OP_MODE) field indicating a selected one of the RSC mode that increases the SCI value in step increments and a conventional RSC mode.

9. The RSC mode control method of claim 1, wherein the at least one parameter comprises at least two of the RSCI value, the RSC mode operation time, the number of operation periods, and the SCI operation time of each slot period.

10. The RSC mode control method of claim 1, wherein the at least one parameter comprises operation time fraction information of an initial SCI.

11. The RSC mode control method of claim 10, wherein:
if the SCI operation time of each slot period is defined as t and the operation time fraction is defined as p, an operation time of a first operation period is determined as p*t, an operation time of a last operation period is determined as (1−p)*t, and the SCI operation time of each slot period in the other operation period except for the first operation period and the last operation period is determined by the following equation as,
$$t = \frac{T}{n - 1}$$
wherein p denotes a real number having a range of 0≦p≦1, T denotes the RSC mode operation time, and n denotes the number of operation periods.

12. The RSC mode control method of claim 1, wherein the performing step is executed in a reduced slot cycle index (RSCI) as an initial value of the SCI determined between the mobile station and the base station, wherein the RSCI has a value smaller than an SCI value.

13. A mobile station apparatus for performing a reduced slot cycle (RSC) mode for observing a paging slot to receive a message transmitted from a base station in a mobile communication system, the apparatus comprising:
a radio frequency (RF) transmission/reception module for exchanging a radio signal with the base station;
a message processor for transmitting and receiving various messages including parameters for control of the RSC mode; and
an RSC controller for determining at least one parameter related to a total operation time of the RSC mode and a number of operation periods wherein the mobile station operates with different slot cycle indexes (SCIs), through an exchange of at least one message with the base station,
calculating a SCI operation time of each slot period in the RSC mode using the determined parameter, and
performing the RSC mode in the each slot period in a reduced slot cycle index (RSCI) as an initial value of the SCI determined between the mobile station and the base station, wherein the RSCI has a value smaller than an SCI value.

14. The mobile station apparatus of claim 13, wherein the RSC controller is configured to set the SCI operation time of each slot period equally for each of the operation periods.

15. The mobile station apparatus of claim 13, wherein the RSC controller is configured to set the SCI operation time of each slot period differently for at least one operation period.

16. The mobile station apparatus of claim 13, wherein:
at least one of messages exchanged with the base station further comprises an RSC operation mode (RSC_OP_MODE) field indicating a selected one of the RSC mode that increases the SCI value in step increments and a conventional RSC mode, and
wherein the RSC controller is configured to increase the SCI value in step increments depending on the RSC_OP_MODE field.

17. The mobile station apparatus of claim 13, wherein the at least one parameter comprises at least two of the RSCI value, the RSC mode operation time, the number of operation periods, and the SCI operation time of each slot period.

18. The mobile station apparatus of claim 13, wherein the at least one parameter comprises operation time fraction information of an initial SCI.

19. The mobile station apparatus of claim 18, wherein:
if the SCI operation time of each slot period is defined as t and the operation time fraction is defined as p, an operation time of a first operation period is determined as p*t, an operation time of a last operation period is determined as (1−p)*t, and the SCI operation time of each slot period in the other operation period except for the first operation period and the last operation period is determined by the following equation as,
$$t = \frac{T}{n - 1}$$
wherein p denotes a real number having a range of 0≦p≦1, T denotes the RSC mode operation time, and n denotes the number of operation periods.

20. A base station apparatus that operates in a reduced slot cycle (RSC) mode by exchanging a message with a mobile station that periodically observes a paging slot, in a mobile communication system, the apparatus comprising:
a radio frequency (RF) transmission/reception module for exchanging a radio signal with the mobile station;
a message processor for transmitting and receiving various messages including parameters for control of the RSC mode; and
an RSC controller for determining at least one parameter related to a total operation time of the RSC mode and a number of operation periods where the base station operates with different slot cycle indexes (SCIs), through an exchange of a message with the mobile station,
calculating a SCI operation time of each slot period using the determined parameter, and
performing the RSC mode in the each slot period in a reduced slot cycle index (RSCI) as an initial value of the SCI determined between the mobile station and the base station, wherein the RSCI has a value smaller than an SCI value.

21. The base station apparatus of claim 20, wherein the at least one parameter comprises at least two of the RSCI value, the RSC mode operation time, the number of operation periods, and the SCI operation time of each slot period.

22. The base station apparatus of claim 20, wherein the at least one parameter comprises operation time fraction information of an initial SCI.

23. The base station apparatus of claim 22, wherein:
if the SCI operation time of each slot period is defined as t and the operation time fraction is defined as p, an operation time of a first operation period is determined as p*t, an operation time of a last operation period is determined as (1−p)*t, and the SCI operation time of each slot period in the other operation period except for the first operation period and the last operation period is determined by the following equation as,
$$t = \frac{T}{n - 1}$$
wherein p denotes a real number having a range of 0≦p≦1, T denotes the RSC mode operation time, and n denotes the number of operation periods.

24. A mobile communication system that controls a reduced slot cycle (RSC) mode in which a mobile station in an idle state observes a paging slot to receive a message transmitted from a base station, the system comprising:
the mobile station for determining at least one parameter related to an operation time of the RSC mode and the number of operation periods where the mobile station operates with different slot cycle indexes (SCIs), through an exchange of at least one message with the base station,
calculating a per-SCI operation time in the RSC mode operation time using the determined parameter, and starting the RSC mode,
setting a reduced slot cycle index (RSCI) as an initial value of the SCI determined between the mobile station and the base station, the RSCI having a value smaller than an SCI value of an idle state, and
increasing the SCI value in step increments each time the SCI operation time of each slot period arrives and terminating the RSC mode if the increased SCI value reaches the SCI value of the idle state; and
the base station for recognizing start of the RSC mode by the mobile station by exchanging the message with the mobile station, and providing the parameter to the mobile station.
